(19) United States
(12) Patent Application Publication
(10) Pub. No.: US 2026/0086254 A1
(43) Pub. Date: Mar. 26, 2026

(54) MEASUREMENT SYSTEM, DATA PROCESSING APPARATUS, AND MEASURING APPARATUS

(71) Applicant: SEISGADGET LTD., Tokyo (JP)

(72) Inventor: Satoshi SHIMIZU, Kanagawa (JP)

(73) Assignee: SEISGADGET LTD., Tokyo (JP)

(21) Appl. No.: 19/409,606

(22) Filed: Dec. 4, 2025

Related U.S. Application Data
(63) Continuation of application No. PCT/JP2024/011321, filed on Mar. 22, 2024.

(30) Foreign Application Priority Data
Jun. 15, 2023 (JP) 2023-098681

(51) Int. Cl. G01V 1/16; G01V 1/36; H04B 10/80

(52) U.S. Cl. CPC G01V 1/162; G01V 1/36; H04B 10/80

(57) ABSTRACT

A data processing apparatus has: a data acquiring section that acquires a plurality of pieces of measurement data generated by a measuring apparatus; a time difference identifying section that identifies: a first time difference which is a difference between an absolute start time of a time point when the measurement period has started and the internal time associated with the measurement data obtained at the time point when the measurement period has started and a second time difference which is a difference between an absolute end time of a time point when the measurement period has ended and the internal time associated with the measurement data obtained at the time point when the measurement period has ended; and a correcting section that corrects the internal time associated with the plurality of pieces of measurement data on the basis of the first time difference and the second time difference.

### CROSS-REFERENCE TO RELATED APPLICATIONS

The present application is a continuation application of International Application number PCT/JP2024/011321, filed on Mar. 22, 2024, which claims priority under 35 U.S.C § 119(a) to Japanese Patent Application No. 2023-098681, filed on Jun. 15, 2023, contents of which are incorporated herein by reference in their entirety.

The present disclosure relates to a measurement system, a data processing apparatus, and a measuring apparatus.

### BACKGROUND OF THE INVENTION

Systems in which vibrations on the seafloor are measured using seismic exploration equipment installed on the seafloor have been known. Japanese Patent Application Publication No. 2021-501871 discloses a technology in which, by connecting seismic exploration equipment to a PTP (Precision Time Protocol) network using a cable, the seismic exploration equipment is allowed to recognize the accurate time to prevent the effect of clock drift in a measuring apparatus from affecting measurement results.

In a case where a large number of measuring apparatuses are installed on the seafloor, and each measuring apparatus performs measurement, there is a problem that cable wiring costs increase undesirably if the large number of measuring apparatuses are connected to a PTP network using cables.

### BRIEF SUMMARY OF THE INVENTION

The present disclosure has been made in view of these matters, and an object thereof is to mitigate the effect of clock drift in measurement results of measuring apparatuses installed on the seafloor.

A measurement system according to a first aspect of the present disclosure includes a measuring apparatus installed on a seafloor; and a data processing apparatus that analyzes measurement data of a natural seismic wave detected by the measuring apparatus in response to generation of a seismic wave toward the seafloor from a seismic source during a measurement period from a ship sailing a sea. The measuring apparatus has: an oscillator used for time measurement; and a measurement data generating section that generates a plurality of pieces of the measurement data associated with an internal time obtained by the time measurement performed on a basis of the oscillator. Either the measuring apparatus or the data processing apparatus has: a time difference identifying section that identifies: (1) a first time difference which is a difference between an absolute start time of a time point when the measurement period has started and the internal time associated with the measurement data obtained at the time point when the measurement period has started and (2) a second time difference which is a difference between an absolute end time of a time point when the measurement period has ended and the internal time associated with the measurement data obtained at the time point when the measurement period has ended; and a correcting section that corrects the internal time associated with the plurality of pieces of measurement data at least on a basis of the first time difference and the second time difference.

A data processing apparatus according to a second aspect of the present disclosure has: a data acquiring section that acquires a plurality of pieces of measurement data, the plurality of pieces of measurement data representing a natural seismic wave detected by a measuring apparatus installed on a seafloor in response to generation of a seismic wave toward the seafloor from a seismic source during a measurement period from a ship sailing a sea, the plurality of pieces of measurement data being generated by the measuring apparatus and associated with an internal time obtained by time measurement performed at the measuring apparatus; a time difference identifying section that identifies: (1) a first time difference which is a difference between an absolute start time of a time point when the measurement period has started and the internal time associated with the measurement data obtained at the time point when the measurement period has started and (2) a second time difference which is a difference between an absolute end time of a time point when the measurement period has ended and the internal time associated with the measurement data obtained at the time point when the measurement period has ended; and a correcting section that corrects the internal time associated with the plurality of pieces of measurement data at least on a basis of the first time difference and the second time difference.

A measuring apparatus according to a third aspect of the present disclosure is a measuring apparatus that measures, on a seafloor, a natural seismic wave generated in response to generation of a seismic wave toward the seafloor from a seismic source during a measurement period from a ship sailing a sea, the measuring apparatus having: a data generating section that generates a plurality of pieces of measurement data associated with an internal time obtained by time measurement performed at the measuring apparatus; a time difference identifying section that identifies: (1) a first time difference which is a difference between an absolute start time of a time point when the measurement period has started and the internal time associated with the measurement data obtained at the time point when the measurement period has started and (2) a second time difference which is a difference between an absolute end time of a time point when the measurement period has ended and the internal time associated with the measurement data obtained at the time point when the measurement period has ended; and a correcting section that corrects the internal time associated with the plurality of pieces of measurement data at least on a basis of the first time difference and the second time difference.

### BRIEF DESCRIPTION OF THE DRAWINGS

FIG. 1A is a drawing illustrating a summary of a measurement system S.

FIG. 1B is a drawing illustrating the summary of the measurement system S.

FIG. 2 is a drawing for explaining a procedure for activating a plurality of measuring apparatuses 4.

FIG. 3 is a drawing illustrating an example of a management table representing the state of each measuring apparatus 4.

FIG. 4 is a diagram illustrating the configuration of a data processing apparatus 1.

FIG. 5 is a diagram illustrating the configuration of a measuring apparatus 4.

FIG. 6A is a drawing for explaining the aging characteristics of an oscillator.

FIG. 6B is a drawing for explaining the aging characteristics of the oscillator.

FIG. 7A is a drawing for explaining the aging characteristics of an oscillator.

FIG. 7B is a drawing for explaining the aging characteristics of the oscillator.

FIG. 8A is a drawing for explaining the difference between a case where a second time difference is calculated using acoustic signals at a measurement end time point and a case where the second time difference is calculated using optical signals.

FIG. 8B is a drawing for explaining the difference between the case where the second time difference is calculated using the acoustic signals at the measurement end time point and the case where the second time difference is calculated using the optical signals.

FIG. 9 is a diagram illustrating the configuration of a measuring apparatus 4 whose frequency can be calibrated.

FIG. 10A is a drawing for explaining calibration of the frequency of an oscillator 41 by a calibrating section 483.

FIG. 10B is a drawing for explaining the calibration of the frequency of the oscillator 41 by the calibrating section 483.

FIG. 11 is a flowchart illustrating a processing procedure performed in the data processing apparatus 1.

FIG. 12 is a flowchart illustrating the processing procedure performed in the data processing apparatus 1.

FIG. 13 is a flowchart illustrating the procedure of a measurement data correction process (S25).

FIG. 14 is a diagram illustrating the configuration of a data processing apparatus 1A according to a first modification example.

FIG. 15 is a diagram illustrating the configuration of a measuring apparatus 4A according to the first modification example.

FIG. 16 is a flowchart illustrating a processing procedure performed in the data processing apparatus 1A according to the first modification example.

FIG. 17 is a flowchart illustrating a processing procedure performed in a measuring apparatus 4A according to the first modification example.

FIG. 18 is a diagram illustrating the configuration of a data processing apparatus 1B according to a second modification example.

FIG. 19 is a diagram illustrating the configuration of a measuring apparatus 4B according to the second modification example.

### DETAILED DESCRIPTION OF THE INVENTION

Hereinafter, the present disclosure will be described through exemplary embodiments, but the following exemplary embodiments do not limit the disclosure according to the claims, and not all of the combinations of features described in the exemplary embodiments are necessarily essential to the solution means of the disclosure.

### [Summary of Measurement System S]

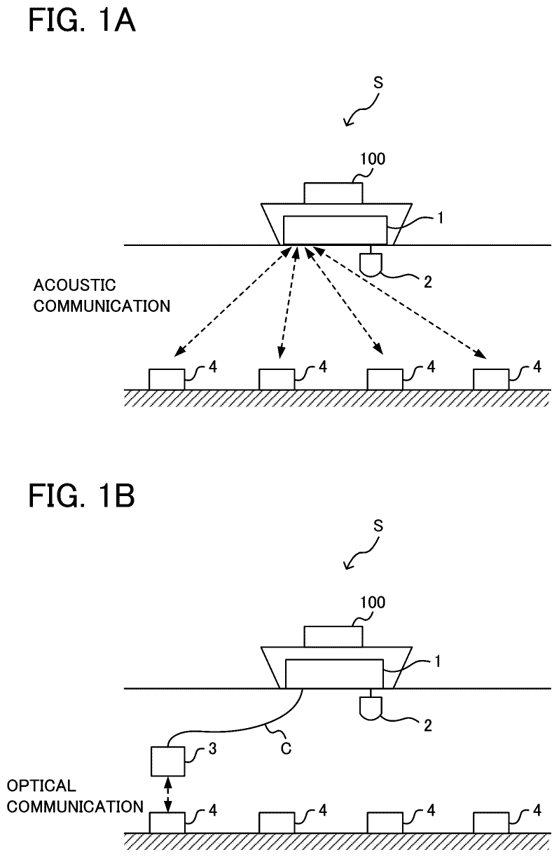

FIG. 1 is a drawing illustrating a summary of a measurement system S. The measurement system S is a marine geophysical exploration system for analyzing sub-seafloor geological structures. In the measurement system S, seismic waves are generated from a seismic source 2 such as an air gun or a sparker, and a data processing apparatus 1 analyzes sub-seafloor geological structures using results of measurement of the seismic waves by a large number of measuring apparatuses 4 installed on the seafloor.

The measurement system S includes the data processing apparatus 1, the seismic source 2, an optical communication apparatus 3, and a plurality of the measuring apparatuses 4. The data processing apparatus 1, the seismic source 2, and the optical communication apparatus 3 are mounted on a ship 100 that can move through the ocean. The plurality of measuring apparatuses 4 are installed on the seafloor at intervals equal to or greater than a predetermined distance.

For example, the data processing apparatus 1 is a computer. The data processing apparatus 1 acquires measurement data representing the seismic state of the seafloor observed at the plurality of measuring apparatuses 4 at the timings when seismic waves are generated and analyzes the acquired measurement data. That is, together with the measuring apparatuses 4 installed on the seafloor, the data processing apparatus 1 analyzes measurement data of natural seismic waves detected by the measuring apparatuses 4 in response to the generation of the seismic waves toward the seafloor from the seismic source 2 during a measurement period from the ship sailing the sea. As illustrated in FIG. 1A, the data processing apparatus 1 controls the plurality of measuring apparatuses 4 by transmitting and receiving acoustic signals and receives measurement data generated by the plurality of measuring apparatuses 4. In addition, for example, the data processing apparatus 1 acquires information representing the absolute time from a PTP network or a GPS (Global Positioning System).

The seismic source 2 generates seismic waves during a measurement period. For example, the seismic source 2 generates seismic waves under the control of the data processing apparatus 1, but may generate seismic waves under the control of a control apparatus different from the data processing apparatus 1 (e.g. a computer mounted on a vessel different from the ship 100).

The optical communication apparatus 3 acquires measurement data from at least one measuring apparatus 4 by performing optical communication with the measuring apparatus 4 under the control of the data processing apparatus 1. The optical communication apparatus 3 generates a first optical signal to measuring apparatuses 4 underwater and receives a second optical signal transmitted by measuring apparatuses 4 having received the first optical signal. The optical communication apparatus 3 is connected to the data processing apparatus 1 through a cable C and performs optical communication with measuring apparatuses 4 after submerging to a position where the optical communication apparatus 3 can perform optical communication with the measuring apparatuses 4 under the control of the data processing apparatus 1. The optical communication apparatus 3 sequentially moves to the vicinity of each of the plurality of measuring apparatuses 4 and sequentially acquires measurement data from the plurality of measuring apparatuses 4. Note that the measurement system S may have a plurality of the optical communication apparatuses 3, and the plurality of optical communication apparatuses 3 may acquire measurement data from the plurality of measuring apparatuses 4.

Each measuring apparatus 4 generates measurement data representing the vibration amount of the measuring apparatus 4. The measurement data represents the vibration amount of the measuring apparatus 4 caused by seismic waves. The measurement data is data representing the magnitude of vibration detected by a sensor that the measuring apparatus 4 has and, for example, is data including measurement values generated by sampling signals output by the sensor at 1-millisecond intervals. The measurement data is associated with the internal time measured by an oscillator positioned inside the measuring apparatus 4. The measuring apparatus 4 transmits the measurement data to the optical communication apparatus 3 using an optical signal.

Meanwhile, since the internal time of the measuring apparatus 4 is a time measured by the built-in oscillator of the measuring apparatus 4, the internal time is different from the absolute time. Furthermore, due to the effect of the aging characteristics of the oscillator that the measuring apparatus 4 has, the frequency of the oscillator changes over time. As a result, a difference arises between the internal time associated with the measurement data by the measuring apparatus 4 and the absolute time. Even if a chip scale atomic clock (CSAC: Chip Scale Atomic Clock) with relatively favorable aging characteristics is used as the oscillator, a frequency offset occurs undesirably overtime. If there is a difference between the absolute time and the internal time, the relationship between the timings at which the seismic source 2 has generated seismic waves and the timings of natural seismic waves represented by measurement data cannot be identified highly precisely. This causes a problem that the precision of sub-seafloor geological structure analysis based on natural seismic waves lowers undesirably.

In view of this, the data processing apparatus 1 identifies the time difference between the absolute time and the internal time of the measuring apparatus 4 using acoustic signals or optical signals at a measurement start time point and a measurement end time point, and, on the basis of the identified result, corrects the internal time associated with measurement data. In a case where the oscillator that the measuring apparatus 4 has exhibits a nearly constant change amount per unit time of the frequency offset regardless of the lapse of time, the time difference between the absolute time and the internal time of each measurement time point of the measurement period also changes linearly. That is, the time difference per unit time is nearly constant. The data processing apparatus 1 uses this feature to calculate the difference between the internal time corresponding to each measurement value and the absolute time by multiplying the elapsed time from the measurement start time point by the change amount per unit time of the time difference. The data processing apparatus 1 corrects the internal time associated with measurement data on the basis of the calculated time difference.

By operating in this manner, the data processing apparatus 1 need not identify the time difference between the absolute time and the internal time of a measuring apparatus 4 continuously using acoustic signals or optical signals during measurement by the measuring apparatus 4, and it is sufficient if the data processing apparatus 1 identifies the time difference at the measurement start time point and the measurement end time point. Accordingly, even if the plurality of measuring apparatuses 4 are not connected to a PTP network, the data processing apparatus 1 can analyze measurement data highly precisely without significantly lowering measurement efficiency.

### [Activation Procedure of Measuring Apparatuses 4]

Measurement for analyzing sub-seafloor geological structures is implemented regularly. For example, measurement is implemented once a year over several days to several weeks. If a plurality of measuring apparatuses 4 are installed each time a measurement implementation period comes, the installation work takes an enormous amount of time, thereby worsening measurement efficiency. In view of this, the measurement system S in the present embodiment has configuration in which a plurality of measuring apparatuses 4 installed on the seafloor in advance are caused to measure natural seismic waves during a plurality of measurement periods spanning a plurality of years.

Since the measuring apparatuses 4 operate on batteries, operations in a state in which the measuring apparatuses 4 are installed on the seafloor over a long period undesirably result in consumption of the batteries in a short time. In view of this, the measurement system S has configuration in which the plurality of measuring apparatuses 4 are activated at the time point when a measurement period starts, and the plurality of measuring apparatuses 4 stop measurement operations when the measurement period ends. The measuring apparatuses 4 having stopped the measurement operations enter a sleep state in which oscillators that the measuring apparatuses 4 have are stopped to reduce power consumption, while maintaining the function of receiving acoustic signals from the data processing apparatus 1. For example, the measuring apparatuses 4 have a measurement state in which measurement is being executed, a standby state in which the oscillators are in operation, and measurement is not being executed, and a sleep state in which the oscillators are stopped, and measurement is not being executed.

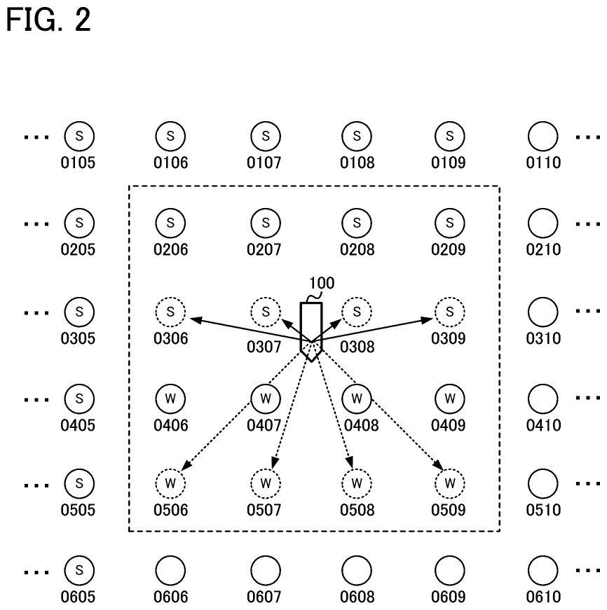

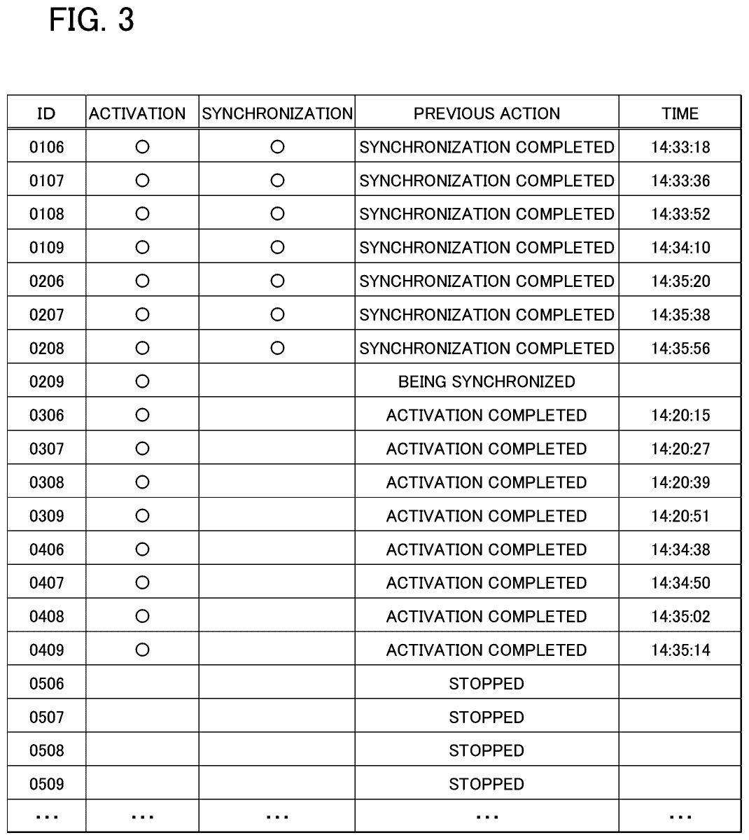

FIGS. 2 and 3 are drawings for explaining a procedure for activating a plurality of measuring apparatuses 4. FIG. 2 schematically illustrates a state in which the plurality of measuring apparatuses 4 are seen from above. Circles (O) illustrated in FIG. 2 represent the measuring apparatus 4 installed on the seafloor. The numerals under the circles are identification information (ID) for identifying the measuring apparatuses 4.

While the ship 100 is moving, the data processing apparatus 1 causes measuring apparatuses 4 in the acoustic signal coverage area (e.g. the area enclosed by the dashed-line frame in FIG. 2) to enter a state in which the measuring apparatuses 4 can start measurement operations by transmitting acoustic signals including control information to the measuring apparatuses 4. Specifically, the data processing apparatus 1 causes the measuring apparatuses 4 to enter a state in which the measuring apparatuses 4 can start measurement operations by transmitting an activation command, a synchronization command, and a recording start command. Dashed-line arrows in FIG. 2 represent the activation command, and solid-line arrows represent the synchronization command. The data processing apparatus 1 may transmit, to the measuring apparatuses 4, parameters necessary for measurement (e.g. sampling interval or preamplifier gain).

The activation command includes a string corresponding to an instruction for transitioning measuring apparatuses 4 from the sleep state to a measurement-enabled state and the IDs of the measuring apparatuses 4. The synchronization command includes a string corresponding to an instruction for requesting the internal times of measuring apparatuses 4 and the IDs of the measuring apparatuses 4. The data processing apparatus 1 may transmit the synchronization command including the absolute time recognized by the data processing apparatus 1. In the following explanation, a process in which the data processing apparatus 1 identifies the relationship between the absolute time and the internal time of a measuring apparatus 4 on the basis of the internal time received from the measuring apparatus 4 by transmitting the synchronization command to the measuring apparatus 4 is referred to as “synchronization.” The recording start command includes a string corresponding to an instruction for starting measurement data recording and the IDs of measuring apparatuses 4.

Measuring apparatuses 4 without characters written in circles illustrated in FIG. 2 (e.g. the measuring apparatus 4 with the ID 0606) are in an operation-stopped state. “W” written in dashed-line circles represents that the measuring apparatuses 4 have received the activation command and are executing an activation process. “W” written in solid-line circles represents that the measuring apparatuses 4 are in an activation-completed state, but are in a synchronization-incomplete state. “S” written in dashed-line circles represents that the measuring apparatuses 4 have received the synchronization command and are executing a synchronization process. “S” written in solid-line circles represents that the measuring apparatuses 4 are in a synchronization-completed state.

FIG. 3 is a drawing illustrating an example of a management table representing the state of each measuring apparatus 4. In the management table illustrated in FIG. 3, the ID of each measuring apparatus 4, information representing whether or not activation has been completed, information representing whether or not synchronization has been completed, the previous action (i.e. an action that has been executed immediately before), and the time at which the action has been performed are associated with each other. As can be known from the states of the plurality of measuring apparatuses 4 in the dashed-line area in FIG. 2 and the times in the management table in FIG. 3, the data processing apparatus 1 transmits the activation command and the synchronization command to different measuring apparatuses 4 in a time division manner.

Specifically, after the transmission of the activation command to a first measuring apparatus 4 and before the completion of the activation of the first measuring apparatus 4, the data processing apparatus 1 transmits the synchronization command to a second measuring apparatus 4 having been activated. By sequentially activating and then synchronizing a plurality of measuring apparatuses 4 in this manner, the data processing apparatus 1 can cause the plurality of measuring apparatuses 4 to enter the measurement-enabled state in a shorter time than in a case where the activation command is transmitted to the measuring apparatuses 4, and the activation of the measuring apparatuses 4 is waited for. In addition, it is possible to cause measuring apparatuses 4 to enter the measurement-enabled state surely in a shorter time as compared to a case where a human activates individual measuring apparatuses 4.

In addition, the data processing apparatus 1 activates the plurality of measuring apparatuses 4 while advancing in the same direction. As an example, as illustrated in FIG. 2, the data processing apparatus 1 transmits the activation command to a plurality of measuring apparatuses 4 located ahead of the ship 100 and, after the ship 100 has moved to a position before the plurality of measuring apparatuses 4 having been activated, transmits the synchronization command to the plurality of measuring apparatuses 4 having been activated.

In this manner, the data processing apparatus 1 transmits commands to a plurality of measuring apparatuses 4 that are located ahead of the ship 100 on which the data processing apparatus 1 is mounted and are capable of receiving acoustic signals and to a plurality of measuring apparatuses 4 that are located behind the ship 100 and are capable of receiving acoustic signals. By operating in this manner, the data processing apparatus 1 can cause a plurality of measuring apparatuses 4 to enter the measurement-enabled state in a shorter time as compared to a case where the data processing apparatus 1 transmits a command only to measuring apparatuses 4 that are located either ahead of or behind the ship 100.

Note that, although not illustrated in FIGS. 2 and 3, after the reception of responses to the synchronization command from measuring apparatuses 4 and the completion of synchronization of the measuring apparatuses 4, the data processing apparatus 1 may transmit the recording start command to the measuring apparatuses 4 that have completed synchronization. The recording start command may be a command including an instruction for promptly starting recording or may be a command representing a time at which recording is to be started. The data processing apparatus 1 may transmit the recording start command consecutively to a plurality of measuring apparatuses 4 after the completion of synchronization of all the measuring apparatuses 4 and before the generation of seismic waves by the seismic source.

Installing a large number of measuring apparatuses 4 on the seafloor each time measurement is performed incurs enormous time and cost for the installation. On the other hand, keeping measuring apparatuses 4 in an operational state for a long period undesirably causes a problem that the batteries are consumed. In the measurement system S, the data processing apparatus 1 sequentially activates and synchronizes a plurality of measuring apparatuses 4 before a measurement period and causes the measuring apparatuses 4 to enter the sleep state when the measurement period ends to reduce battery depletion. By being configured in this manner, the measurement system S can cause a large number of measuring apparatuses 4 to measure natural seismic waves efficiently for a long period.

### [Configuration of Data Processing Apparatus 1]

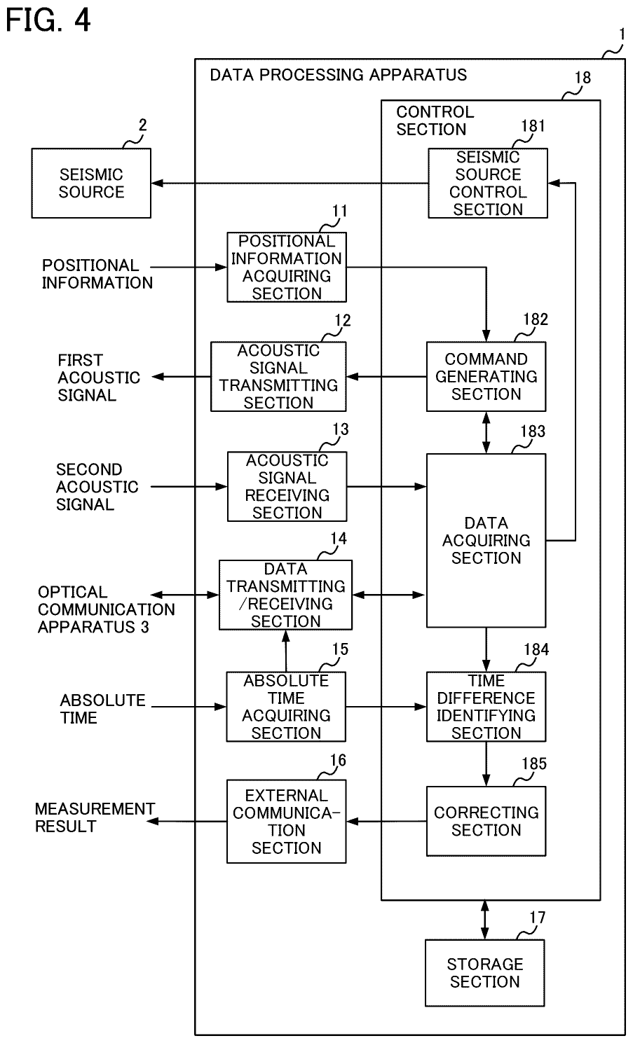

FIG. 4 is a diagram illustrating the configuration of the data processing apparatus 1. The data processing apparatus 1 has a positional information acquiring section 11, an acoustic signal transmitting section 12, an acoustic signal receiving section 13, a data transmitting/receiving section 14, an absolute time acquiring section 15, an external communication section 16, a storage section 17, and a control section 18. The control section 18 has a seismic source control section 181, a command generating section 182, a data acquiring section 183, a time difference identifying section 184, and a correcting section 185. Note that some of the functional sections that the control section 18 has may be provided to an apparatus other than the data processing apparatus 1.

The positional information acquiring section 11 acquires positional information representing the position of the data processing apparatus 1, that is, the position of the ship 100 on which the data processing apparatus 1 is mounted. For example, the positional information acquiring section 11 acquires radio waves received from GPS satellites as the positional information and identifies the latitude/longitude on the basis of the acquired positional information. The positional information acquiring section 11 notifies the command generating section 182 of the identified latitude/longitude.

The acoustic signal transmitting section 12 is an acoustic communication unit that transmits a first acoustic signal to measuring apparatuses 4. For example, under the control of the command generating section 182, the acoustic signal transmitting section 12 transmits the first acoustic signal including control data (e.g. various types of command) input from the command generating section 182. By referring to the individual positions of a plurality of measuring apparatuses 4 stored in the storage section 17, the acoustic signal receiving section 13 transmits the first acoustic signal including commands to measuring apparatuses 4 within a predetermined range from the position of the ship 100 represented by the positional information acquired by the positional information acquiring section 11. The predetermined range is a range within which measuring apparatuses 4 can receive the first acoustic signal transmitted by the acoustic signal transmitting section 12.

As an example, the acoustic signal transmitting section 12 transmits, to each of the plurality of measuring apparatuses 4, the first acoustic signal including the activation command, which is activation data for activating the measuring apparatus 4. The acoustic signal transmitting section 12 transmits the first acoustic signal including the synchronization command representing the absolute time (i.e. the synchronization command including time data) to a measuring apparatus 4 from which a second acoustic signal including response data to the activation command has been received by the acoustic signal receiving section 13.

In addition, the acoustic signal transmitting section 12 transmits, to a measuring apparatus 4 from which a response to the first acoustic signal including the synchronization command has been received by the acoustic signal receiving section 13, the first acoustic signal including the recording start command, which is recording start data representing an instruction for starting measurement data recording. That is, the acoustic signal transmitting section 12 transmits the first acoustic signal including the recording start data to a measuring apparatus 4 having transmitted response data to the synchronization command.

The acoustic signal transmitting section 12 may transmit the recording start command including the ID of one measuring apparatus 4 or may transmit the recording start command including the IDs of a plurality of measuring apparatuses 4 having completed synchronization. The acoustic signal transmitting section 12 may transmit the recording start command including information representing that the recording start command is a command that targets all the measuring apparatuses 4. By causing the acoustic signal transmitting section 12 to transmit such a recording start command, it is possible to cause a plurality of measuring apparatuses 4 to start seismic wave recording with a single transmission of the recording start command, thereby enhancing measurement efficiency.

The acoustic signal receiving section 13 is an acoustic communication unit that receives the second acoustic signal generated by a measuring apparatus 4 having received the first acoustic signal. For example, the acoustic signal receiving section 13 receives the second acoustic signal representing the internal time of a measuring apparatus 4. The acoustic signal receiving section 13 identifies the internal time on the basis of time data included in the received acoustic signal and notifies the data acquiring section 183 of the identified internal time.

The data transmitting/receiving section 14 is a communication interface for data transmission and reception performed with the optical communication apparatus 3. For example, the data transmitting/receiving section 14 transmits, to the optical communication apparatus 3, data including an instruction that has been input from the data acquiring section 183 and is for acquiring the internal time from a measuring apparatus 4 and receives time data representing the internal time that the optical communication apparatus 3 has acquired from the measuring apparatus 4.

The data transmitting/receiving section 14 may notify the optical communication apparatus 3 of the absolute time acquired by the absolute time acquiring section 15 and receive time data in which the absolute time of the time point when the optical communication apparatus 3 has acquired the internal time from a measuring apparatus 4 and the internal time are associated with each other. For example, the data transmitting/receiving section 14 receives data representing the internal time that the optical communication apparatus 3 has acquired from a measuring apparatus 4 at a time point which is within a predetermined range from the time point when the last measurement of the measurement period is performed. The data transmitting/receiving section 14 notifies the data acquiring section 183 of the acquired time data.

For example, the absolute time acquiring section 15 acquires the absolute time from GPS satellites. The absolute time acquiring section 15 notifies the time difference identifying section 184 of the acquired absolute time. The absolute time acquiring section 15 may notify the data transmitting/receiving section 14 of the absolute time.

The external communication section 16 transmits a measurement result including measurement data that has been input from the correcting section 185 and is obtained after the internal time has been corrected. The external communication section 16 may transmit the measurement result to an external computer that analyzes the measurement result and executes a process of identifying the sub-seafloor geological structure or may transmit the measurement result to another processing section that the control section 18 has.

The storage section 17 has storage media such as a ROM (Read Only Memory), a RAM (Random Access Memory), and an SSD (Solid State Drive). The storage section 17 stores programs to be executed by the control section 18. In addition, the storage section 17 stores various types of data for causing a plurality of measuring apparatuses 4 to execute measurement. For example, the storage section 17 stores the position of each of the plurality of measuring apparatuses 4 and identification information about the measuring apparatus 4 in association with each other. Specifically, the storage section 17 stores the latitudes/longitudes of the plurality of measuring apparatuses 4 in association with the IDs of the measuring apparatuses 4.

In addition, the storage section 17 stores a management table like the one illustrated in FIG. 3. Furthermore, the storage section 17 stores a plurality of pieces of measurement data acquired from the plurality of measuring apparatuses 4 in association with the IDs of the measuring apparatuses 4. The storage section 17 stores the plurality of pieces of measurement data in association with the internal times of the measuring apparatuses 4 obtained at the time point when the measurement data has been generated. Thereafter, after times that are obtained by correction of the internal times by the correcting section 185 are associated with the measurement data, the storage section 17 stores the measurement data in association with the corrected times.

For example, the control section 18 has a CPU (Central Processing Unit). By executing a program stored in the storage section 17, the control section 18 functions as the seismic source control section 181, the command generating section 182, the data acquiring section 183, the time difference identifying section 184, and the correcting section 185.

The seismic source control section 181 transmits an instruction for generating seismic waves to the seismic source 2. For example, the seismic source control section 181 causes the seismic source 2 to generate seismic waves after the acoustic signal transmitting section 12 has transmitted the first acoustic signal including the recording start command to a plurality of measuring apparatuses 4. For example, the seismic source control section 181 transmits an instruction for generating seismic waves to the seismic source 2 after having received, from the data acquiring section 183, a notification that all the measuring apparatuses 4 have entered the measurement-enabled state. The seismic source control section 181 may cause the seismic source 2 to generate seismic waves at a predetermined date/time or may cause the seismic source 2 to generate seismic waves in response to the reception of an instruction from an external apparatus. The data processing apparatus 1 may not have the seismic source control section 181, and an external control apparatus may function as the seismic source control section 181.

The command generating section 182 generates commands to be transmitted by the acoustic signal transmitting section 12 to measuring apparatuses 4. For example, the command generating section 182 generates the activation command, the synchronization command, and the recording start command, and inputs the generated commands to the acoustic signal transmitting section 12. When generating a command, the command generating section 182 selects measuring apparatuses 4 within a predetermined range from a latitude/longitude input from the positional information acquiring section 11 by referring to latitudes/longitudes that are stored in the storage section 17 and represent the installation positions of a plurality of measuring apparatuses 4. The command generating section 182 generates commands including the IDs of the selected measuring apparatuses 4.

As explained with reference to FIG. 2, the command generating section 182 generates the activation command for measuring apparatuses 4 in the sleep state in a plurality of the measuring apparatuses 4 within the predetermined range. In response to the reception, from the data acquiring section 183, of a notification that the measuring apparatuses 4 corresponding to the generated activation command have been activated, the command generating section 182 generates the synchronization command for the measuring apparatuses 4. In response to the reception, from the data acquiring section 183, of a notification that the measuring apparatuses 4 corresponding to the generated synchronization command have completed synchronization, the command generating section 182 generates the recording start command for the measuring apparatuses 4.

After inputting the generated commands to the acoustic signal transmitting section 12, the command generating section 182 updates “previous actions” in the management table stored in the storage section 17. After inputting the activation command to the acoustic signal transmitting section 12, the command generating section 182 changes “previous actions” corresponding to the IDs of measuring apparatuses 4 included in the activation command to “being activated.” After inputting the synchronization command to the acoustic signal transmitting section 12, the command generating section 182 changes “previous actions” corresponding to the IDs of measuring apparatuses 4 included in the synchronization command to “being synchronized.”

The data acquiring section 183 acquires various types of data transmitted from measuring apparatuses 4. The data acquiring section 183 acquires, via the acoustic signal receiving section 13, response data to commands transmitted by the acoustic signal transmitting section 12. The data acquiring section 183 notifies the command generating section 182 that the response data has been acquired.

In a case where response data has been acquired, the data acquiring section 183 updates the content of “previous actions” in the management table stored in the storage section 17. For example, in a case where response data representing that a measuring apparatus 4 has been activated has been acquired, the data acquiring section 183 updates “previous action” corresponding to the ID of the measuring apparatus 4 included in the response data to “activation completed.” In a case where response data including the internal time of a measuring apparatus 4 transmitted in response to the reception of the synchronization command by the measuring apparatus 4 has been acquired, the data acquiring section 183 updates “previous action” corresponding to the ID of the measuring apparatus 4 included in the response data to “synchronization completed.” The data acquiring section 183 causes the storage section 17 to store the absolute time at which the synchronization command has been transmitted and the internal time represented by the response data in association with the ID of the measuring apparatus 4.

In a case where response data representing that a measuring apparatus 4 has started recording has been acquired, the data acquiring section 183 updates “previous action” corresponding to the ID of the measuring apparatus 4 included in the response data to “recording started.” In a case where response commands to the recording start command have been received from all the measuring apparatuses 4, that is, in a case where “previous actions” of all the measuring apparatuses 4 have been changed to “recording started,” the data acquiring section 183 notifies the seismic source control section 181 that measurement can be started.

In addition, the data acquiring section 183 may further acquire a light emission time which is the absolute time at which the optical communication apparatus 3 has generated the first optical signal and the internal time included in the second optical signal received by the optical communication apparatus 3. The second optical signal is an optical signal transmitted by a measuring apparatus 4 in response to the reception of the first optical signal. The data acquiring section 183 causes the storage section 17 to store the light emission time and the internal time in association with the ID of the measuring apparatus 4 and notifies the time difference identifying section 184 of the light emission time and the internal time.

Furthermore, the data acquiring section 183 acquires measurement data from each measuring apparatus 4 via the data transmitting/receiving section 14. The data acquiring section 183 acquires a plurality of pieces of measurement data representing measurement values corresponding to mutually different times. For example, after a measurement period has ended, the data acquiring section 183 acquires, from the data transmitting/receiving section 14, a plurality of pieces of measurement data that the optical communication apparatus 3 has collected from each measuring apparatus 4 by optical communication. By causing the storage section 17 to store the acquired measurement data in association with the IDs of measuring apparatuses 4, the data acquiring section 183 allows the time difference identifying section 184 to refer to the measurement data.

By referring to measurement data stored in the storage section 17, the time difference identifying section 184 identifies the time difference between the absolute time and the internal time of an measuring apparatus 4 associated with measurement data. Specifically, by referring to the absolute time and the internal time stored in the storage section 17 in association with the ID of the measuring apparatus 4, the time difference identifying section 184 identifies a first time difference which is the difference between the absolute start time of the time point when a measurement period has started and the internal time of the measuring apparatus 4 associated with the measurement data obtained at the time point when the measurement period has started. In addition, a second time difference which is the difference between the absolute end time of the time point when the measurement period has ended and the internal time associated with the measurement data obtained at the time point when the measurement period has ended is identified.

The time difference identifying section 184 identifies at least either one of the first time difference or the second time difference on the basis of the difference between the absolute time at which the acoustic signal transmitting section 12 has transmitted the first acoustic signal and the internal time represented by the second acoustic signal received by the acoustic signal receiving section 13. For example, the time difference identifying section 184 identifies the first time difference on the basis of the difference between the absolute time that the command generating section 182 has transmitted in the synchronization command and the internal time of a measuring apparatus 4 included in response data to the synchronization command. In addition, the time difference identifying section 184 identifies the second time difference on the basis of the difference between the absolute time included in a measurement data acquisition request command that the optical communication apparatus 3 has transmitted to a measuring apparatus 4 after a measurement period has ended and the internal time of the measuring apparatus 4 included in response data to the measurement data acquisition request command.

There is time required for the propagation of acoustic signals after the acoustic signal transmitting section 12 transmits the first acoustic signal and before the acoustic signal receiving section 13 receives the second acoustic signal. Accordingly, the absolute time of the time point when the measuring apparatus 4 has received the first acoustic signal is different from the absolute time of the time point when the acoustic signal transmitting section 12 has transmitted the first acoustic signal. In view of this, the time difference identifying section 184 may identify at least either one of the first time difference or the second time difference on the basis of the difference between: a time obtained by adding time required for the first acoustic signal to reach a measuring apparatus 4 to the absolute time at which the acoustic signal transmitting section 12 has transmitted the first acoustic signal; and the internal time represented by the second acoustic signal received by the acoustic signal receiving section 13.

The time difference identifying section 184 may identify at least either one of the first time difference or the second time difference on the basis of the difference between: a time obtained by further adding time required for identifying the internal time after a measuring apparatus 4 has received the first acoustic signal to the absolute time at which the acoustic signal transmitting section 12 has transmitted the first acoustic signal; and the internal time represented by the second acoustic signal. In this manner, by causing the time difference identifying section 184 to use the propagation time of the first acoustic signal and the processing time at a measuring apparatus 4, the precision of identification of the difference between the absolute time and the internal time is enhanced.

The time difference identifying section 184 may identify both the first time difference and the second time difference on the basis of the difference between the absolute time at which the acoustic signal transmitting section 12 has transmitted the first acoustic signal and the internal time included in the second acoustic signal received by the acoustic signal receiving section 13, but may identify at least either of them on the basis of the difference between the light emission time, which is the absolute time at which the optical communication apparatus 3 has transmitted the first optical signal, and the internal time included in the second optical signal that the optical communication apparatus 3 has received from a measuring apparatus 4.

The time difference identifying section 184 may identify at least either one of the first time difference or the second time difference on the basis of the difference between: a time obtained by adding time required for the first optical signal to reach a measuring apparatus 4 to the absolute time at which the optical communication apparatus 3 has transmitted the first optical signal; and the internal time represented by the second optical signal received by the optical communication apparatus 3. The absolute time at which the optical communication apparatus 3 has transmitted the first optical signal may be a time at which the data transmitting/receiving section 14 has given an instruction for transmission of the first optical signal to the optical communication apparatus 3.

The propagation speed of light is faster than that of sound, and the propagation stability of light is higher than that of sound. In addition, the optical communication apparatus 3 generates the first optical signal at a position closer to measuring apparatuses 4 than the data processing apparatus 1 is. Accordingly, the propagation time required for the first optical signal generated by the optical communication apparatus 3 to reach measuring apparatuses 4 is shorter than the propagation time required for the first acoustic signal transmitted by the acoustic signal transmitting section 12 to reach the measuring apparatuses 4 and therefore exhibits less variation. As a result, the time difference identification precision is enhanced by identifying time differences using optical signals.

It should be noted that, if the optical communication apparatus 3 moves to the vicinity of a measuring apparatus 4 at both the measurement start time point and the measurement end time point, time is required for the optical communication apparatus 3 to move to the vicinity of the measuring apparatus 4, undesirably. In view of this, the time difference identifying section 184 identifies the first time difference using an acoustic signal at the measurement start time point and identifies the second time difference using an optical signal at the measurement end time point when the optical communication apparatus 3 has moved to the vicinity of a measuring apparatus 4 for collecting measurement data. Since, by operating in this manner, the time difference identifying section 184 can identify the time difference highly precisely on the basis of the optical signal without an increase in time resulting from movement of the optical communication apparatus 3 for acquiring the internal time, it is possible to achieve both measurement efficiency and measurement precision.

The correcting section 185 reads out a plurality of pieces of measurement data stored in the storage section 17 and corrects the internal time associated with the plurality of pieces of measurement data at least on the basis of the first time difference and the second time difference. The correcting section 185 causes the storage section 17 to store the plurality of pieces of measurement data whose internal times have been corrected.

Specifically, first, the correcting section 185 identifies a change amount per unit time of the difference between the absolute time and the internal time on the basis of: the time difference between the absolute start time, which is the absolute time of the measurement start time point, and the absolute end time, which is the absolute time of the measurement end time point; and the difference between the first time difference and the second time difference. Next, on the basis of the identified change amount, the correcting section 185 corrects the internal time associated with the plurality of pieces of measurement data.

By adding, to the first time difference, a value obtained by multiplying the elapsed time from the absolute start time until the internal time by the change amount per unit time, the correcting section 185 identifies the difference between the absolute time and the internal time at the internal time corresponding to correction-target measurement data. The correcting section 185 corrects the internal time of the correction-target measurement data on the basis of the identified difference. In a case where the change amount per unit time of the frequency offset of the oscillator that an measuring apparatus 4 has is nearly constant regardless of the lapse of time, in this manner, the time difference identifying section 184 can correct the internal time corresponding to measurement data efficiently using the first time difference at the measurement start time point and the second time difference at the measurement end time point.

Note that, during a measurement period also, the data acquiring section 183 may acquire the internal time of a measuring apparatus 4 by transmitting the synchronization command, and the correcting section 185 may correct the internal time of measurement data further on the basis of the difference between the absolute time and the internal time of the measuring apparatus 4 during the measurement period. The correcting section 185 may correct the internal time of measurement data on the basis of the time difference between the internal time and the absolute time identified on the basis of the synchronization command given at a number of time points corresponding to the linearity of the aging characteristics of the oscillator that the measuring apparatus 4 has. By operating in this manner, the correcting section 185 can correct the internal time corresponding to measurement data appropriately in accordance with the aging characteristics of the oscillator that the measuring apparatus 4 has.

### [Configuration of Measuring Apparatus 4]

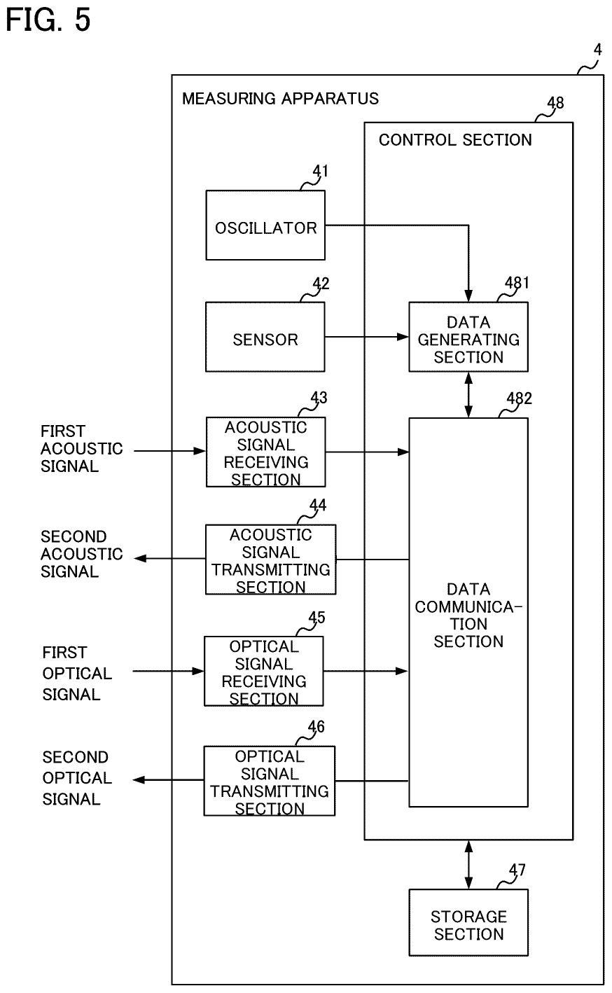

FIG. 5 is a diagram illustrating the configuration of a measuring apparatus 4. The measuring apparatus 4 has an oscillator 41, a sensor 42, an acoustic signal receiving section 43, an acoustic signal transmitting section 44, an optical signal receiving section 45, an optical signal transmitting section 46, a storage section 47, and a control section 48. The control section 48 has a data generating section 481 and a data communication section 482.

The oscillator 41 generates an oscillation signal to be used for time measurement of the internal time at the measuring apparatus 4. As mentioned above, for example, the oscillator 41 is a chip scale atomic clock, but may be another type of oscillator.

The sensor 42 generates a detection signal whose level changes in response to the vibration of the measuring apparatus 4. The sensor 42 inputs the detection signal to the data generating section 481.

The acoustic signal receiving section 43 receives the first acoustic signal transmitted from the data processing apparatus 1. The acoustic signal receiving section 43 inputs, to the data communication section 482, data such as a command and the absolute time included in the received first acoustic signal. In response to the reception of the first acoustic signal by the acoustic signal receiving section 43, the acoustic signal transmitting section 44 transmits, to the data processing apparatus 1, the second acoustic signal representing the internal time at which the first acoustic signal has been received.

The optical signal receiving section 45 receives the first optical signal transmitted from the optical communication apparatus 3. The optical signal receiving section 45 inputs, to the data communication section 482, data such as a command and the absolute time included in the received first optical signal. In response to the reception of the first optical signal by the optical signal receiving section 45, the optical signal transmitting section 46 transmits the second optical signal representing the internal time at which the first optical signal has been received. For example, the optical signal transmitting section 46 transmits, to the optical communication apparatus 3, the second optical signal including the internal time input from the data communication section 482.

The storage section 47 has storage media such as a ROM, a RAM, and an SSD. The storage section 47 stores programs to be executed by the control section 48. In addition, the storage section 47 stores measurement data generated by the data generating section 481.

For example, the control section 48 has a CPU. By executing a program stored in the storage section 47, the control section 48 functions as the data generating section 481 and the data communication section 482.

The data generating section 481 functions as a measurement data generating section that generates a plurality of pieces of measurement data associated with the internal time obtained by the time measurement performed on the basis of the oscillator 41. For example, by sampling detection signals input from the sensor 42 at predetermined time intervals (e.g. 1-millisecond intervals), the data generating section 481 generates a plurality of pieces of measurement data representing the levels of the sampled signals (i.e. measurement values). The data generating section 481 causes the storage section 47 to store the plurality of pieces of measurement data in association with the internal time. Note that the data generating section 481 may perform time measurement of the internal time by counting oscillation signals input from the oscillator 41 or may identify the internal time on the basis of data representing the internal time input from the oscillator 41.

The data communication section 482 transmits, via the acoustic signal transmitting section 44, response data to the command included in the first acoustic signal received from the data processing apparatus 1 via the acoustic signal receiving section 43. In addition, the data communication section 482 transmits, via the optical signal transmitting section 46, response data to the command included in the optical signal received from the optical communication apparatus 3 via the optical signal receiving section 45. In a case where the synchronization command has been received, the data communication section 482 acquires, from the oscillator 41 or the data generating section 481, the internal time at the time point when the synchronization command has been received and transmits response data including the acquired internal time.

In addition, the data communication section 482 transmits a plurality of pieces of measurement data generated by the data generating section 481 to the optical communication apparatus 3 via the optical signal transmitting section 46. Specifically, the data communication section 482 transmits a plurality of pieces of measurement data stored in the storage section 47 in association with the internal time.

### [Aging Characteristics of Oscillator]

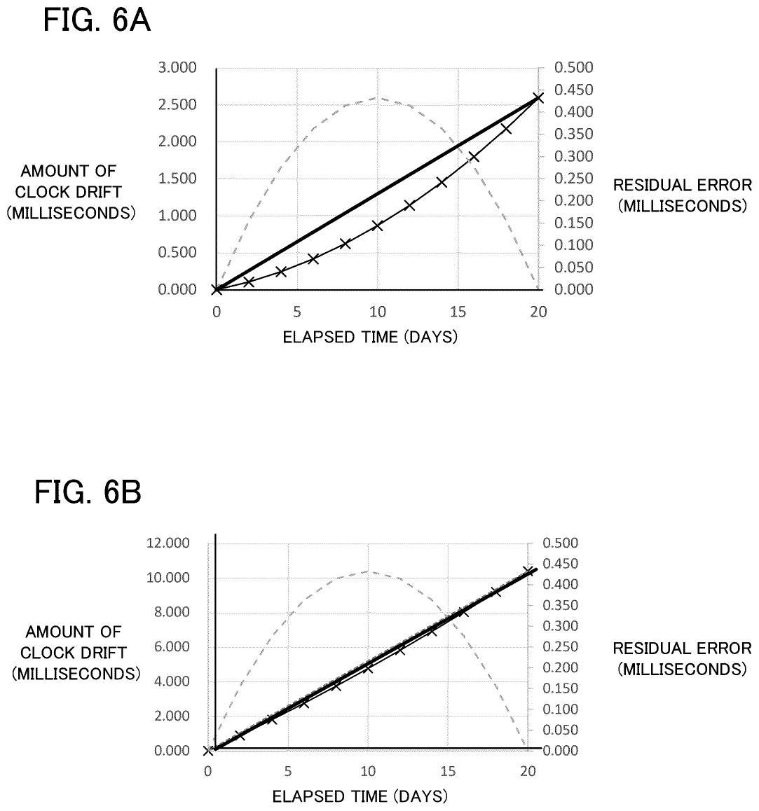

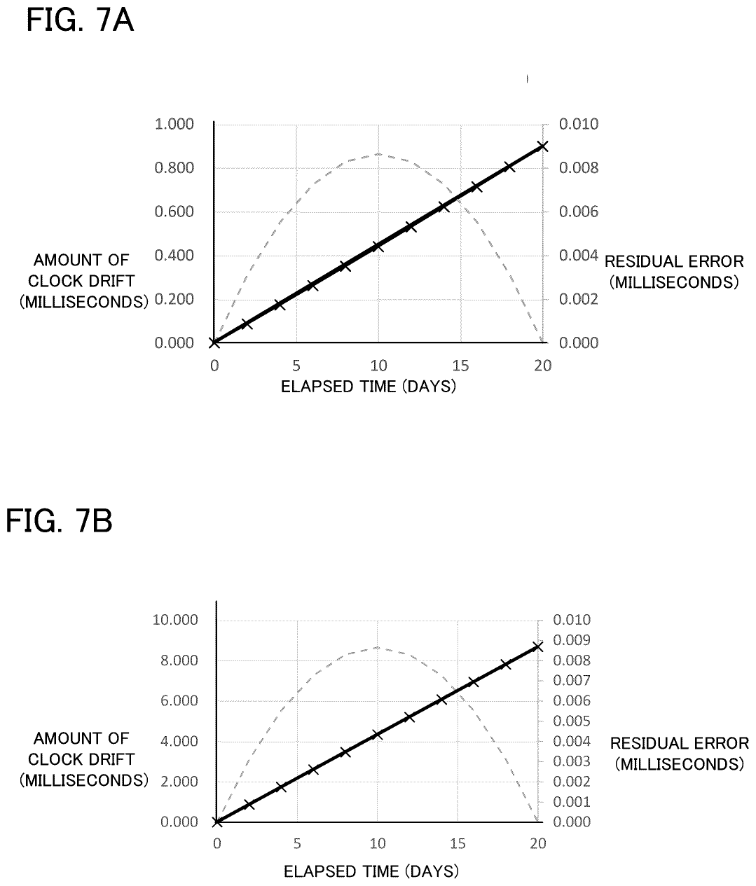

FIGS. 6A, 6B, 7A, and 7B are drawings for explaining the aging characteristics of oscillators. FIGS. 6A and 6B illustrate the characteristics of an oscillator whose aging characteristics are worse than the oscillator 41, and FIGS. 7A and 7B illustrate the aging characteristics of the oscillator 41. FIGS. 6A and 7A illustrate the characteristics in their initial states, and FIGS. 6B and 7B illustrate the characteristics after the lapse of a long period (several years).

The horizontal axes in FIGS. 6A, 6B, 7A, and 7B represent the numbers of days that have elapsed since measurement has been started. Thin solid lines in FIGS. 6A, 6B, 7A, and 7B represent the amounts of clock drift (left vertical axes). Thick solid lines represent states where the amounts of clock drift change linearly over time. Assuming that the amounts of clock drift change as represented by the thick solid-lines, the correcting section 185 corrects the internal time corresponding to a plurality of pieces of measurement data. Dashed lines represent residual errors (right vertical axes) that are observed after the correcting section 185 has corrected the internal time. The residual errors are greatest near the centers of measurement periods, and a maximum residual error of approximately 0.44 milliseconds is observed in FIGS. 6A and 6B.

In contrast, in the example illustrated in FIGS. 7A and 7B, the residual error is approximately 0.009 milliseconds, and it can be known that the correction process performed by the correcting section 185 corrects the internal time corresponding to measurement data highly precisely. In this manner, in a case where a chip scale atomic clock with good aging characteristics is used as the oscillator 41, a process of correcting the internal time corresponding to measurement data during a measurement period on the basis of the first time difference at the measurement start time point and the second time difference at the measurement end time point is particularly effective.

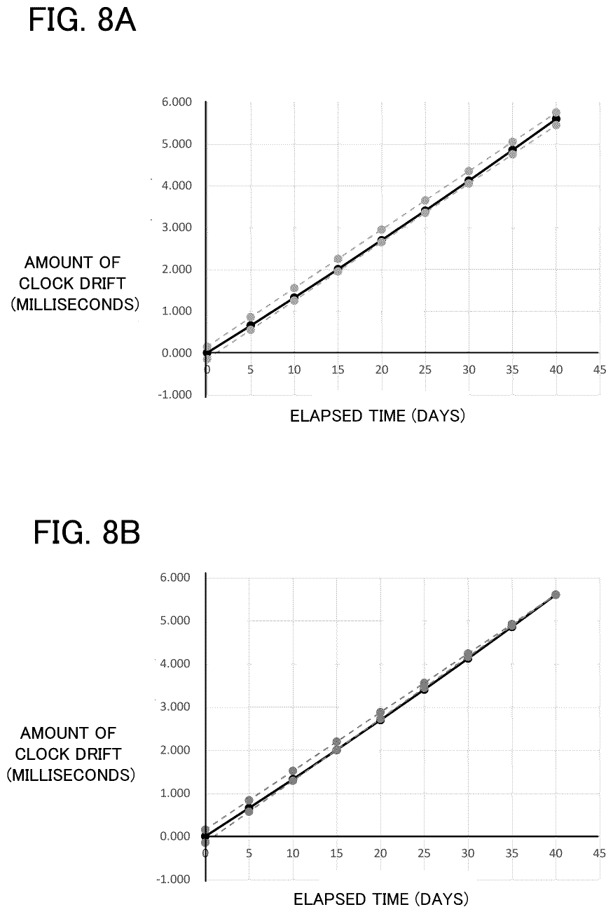

FIGS. 8A and 8B are drawings for explaining the difference between a case where the second time difference is calculated using an acoustic signal at the measurement end time point and a case where the second time difference is calculated using an optical signal. Solid lines represent the amounts of clock drift, and dashed lines represent the maximum value and minimum value of errors after correction. FIG. 8A illustrates a case where the time difference is identified on the basis of acoustic signals at the measurement start time point and the measurement end time point. FIG. 8B illustrates a case where the first time difference is identified on the basis of an acoustic signal at the measurement start time point, and the second time difference is identified on the basis of an optical signal at the measurement end time point.

It is assumed here that the identification of the time difference based on acoustic signals involves an error of ±0.15 milliseconds, and the identification of the time difference based on optical signals involves an error of ±0.01 milliseconds. The maximum residual error value in the example illustrated in FIG. 8A is 0.254 milliseconds; on the other hand, the maximum residual error value in the example illustrated in FIG. 8B is 0.179 milliseconds. In this manner, it can be confirmed that the residual error can be reduced by the identification of the second time difference based on optical signals at the measurement end time point by the time difference identifying section 184.

### [Calibration of Oscillator 41]

Whereas the effect of the frequency offset of the oscillator 41 can be reduced by the process performed by the correcting section 185 according to the present embodiment, a smaller frequency offset is desirable when measurement data acquired during different measurement periods is compared. In view of this, the measurement system S may be configured to calibrate the frequency of the oscillator 41 at the time point when a measurement period has ended.

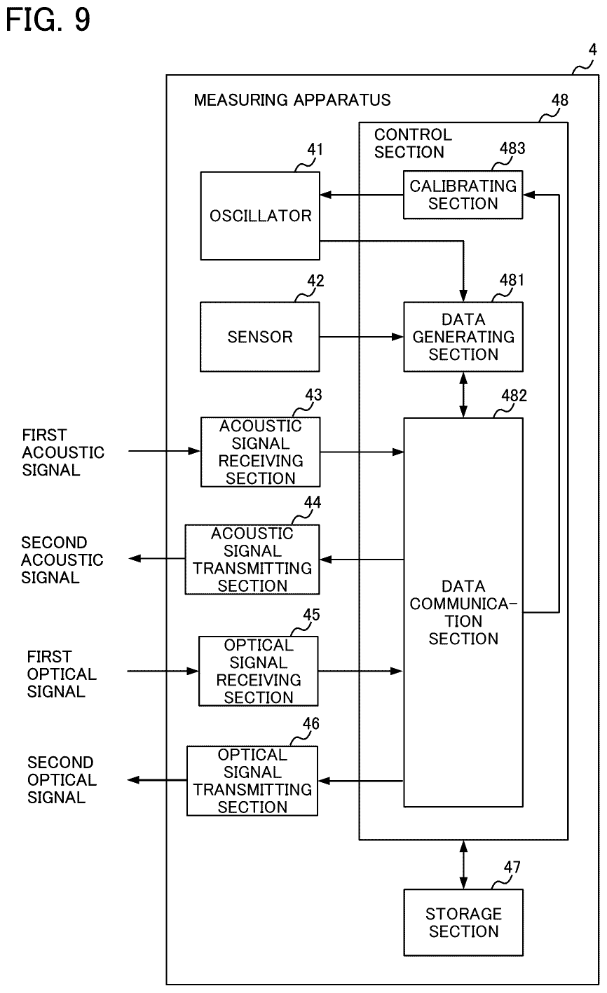

FIG. 9 is a diagram illustrating the configuration of a measuring apparatus 4 whose frequency can be calibrated. The measuring apparatus 4 illustrated in FIG. 9 is different from the measuring apparatus 4 illustrated in FIG. 5 in that the measuring apparatus 4 illustrated in FIG. 9 further has a calibrating section 483, but is the same in other respects.

In order to calibrate the frequency of the oscillator 41, the correcting section 185 identifies the frequency deviation of the oscillator of the measuring apparatus 4 at the time point when a measurement period has ended on the basis of the first time difference and the second time difference and notifies the measuring apparatus 4 of the identified frequency deviation. For example, the correcting section 185 calculates the drift amount per unit time of the internal time by dividing the difference between the first time difference and the second time difference by a measurement period. Since the drift amount per unit time of the internal time is proportional to the magnitude of the frequency deviation, the correcting section 185 can calculate the frequency deviation on the basis of the drift amount per unit time of the internal time.

The calibrating section 483 calibrates the frequency of the oscillator 41 on the basis of the frequency deviation notified from the data processing apparatus 1. Specifically, the calibrating section 483 changes the voltage of a control signal to be used for controlling the oscillation frequency of the oscillator 41 in accordance with the frequency deviation. For example, in a case where the frequency deviation is +1.0×10⁻¹⁰, the control voltage is changed to lower the oscillation frequency of the oscillator 41 by a frequency equivalent to the frequency deviation 1.0×10⁻¹⁰. In a case where the frequency deviation at the time point when a measurement period has ended is equal to or greater than a threshold, the calibrating section 483 may calibrate the frequency of the oscillator 41.

In order to enhance calibration precision, the calibrating section 483 may calibrate the frequency of the oscillator 41 using the average of the time difference, having been acquired multiple times, between the absolute time transmitted in optical signals by the optical communication apparatus 3 over a certain length of time (e.g. ten minutes) and the internal time at the time points when the measuring apparatus 4 has received the optical signals.

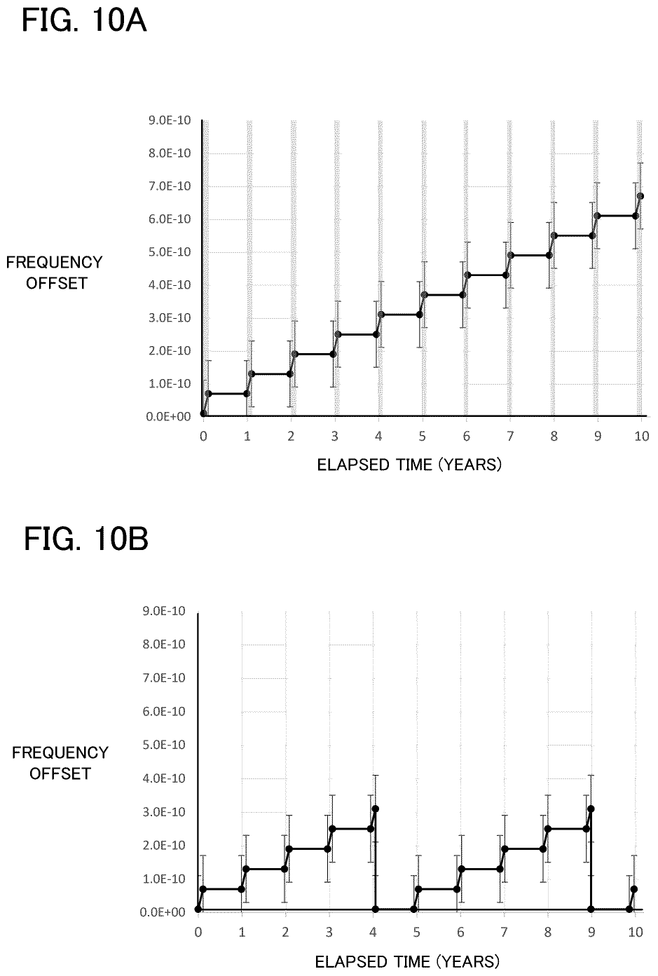

FIGS. 10A and 10B are drawings for explaining calibration of the frequency of the oscillator 41 by the calibrating section 483. It is assumed in FIGS. 10A and 10B that there is a 40-day measurement period once a year. FIGS. 10A and 10B illustrate that the frequency offset increases while the oscillator 41 is in operation, and the frequency offset does not change while the oscillator 41 is stopped. In FIGS. 10A and 10B, error bars extending in the up-down direction at black dots representing the frequency offset represent the error range (the magnitude of instability) caused by power cycles.

FIG. 10A illustrates changes in the frequency deviation in a case where the calibrating section 483 does not calibrate the frequency of the oscillator 41. FIG. 10B illustrates changes in the frequency deviation in a case where the calibrating section 483 calibrates the frequency of the oscillator 41 in a case where the frequency deviation has become equal to or greater than +3.0×10⁻¹⁰. As illustrated in FIG. 10B, the calibration of the frequency of the oscillator 41 by the data acquiring section 183 can keep the frequency deviation within a certain range.

### [Processing Procedure Performed in Data Processing Apparatus 1]

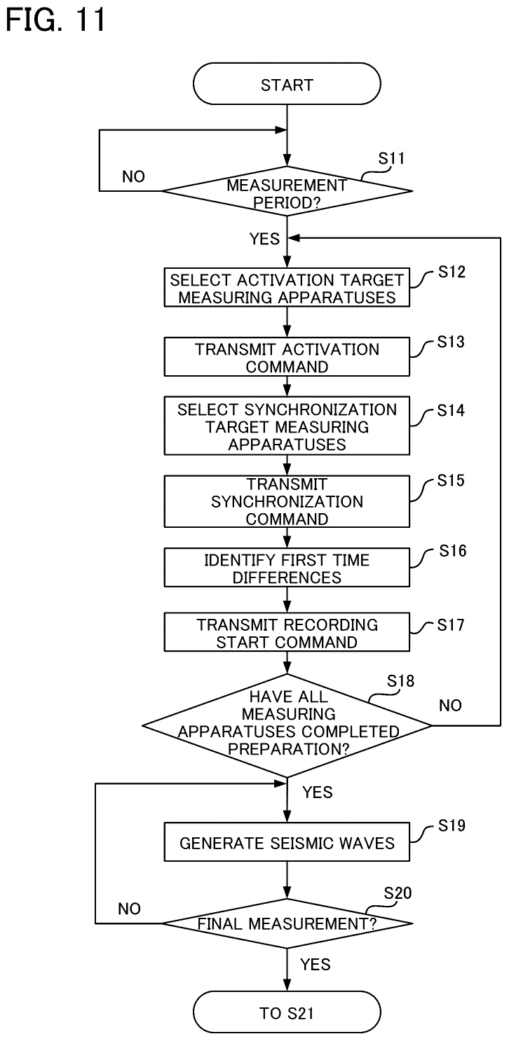

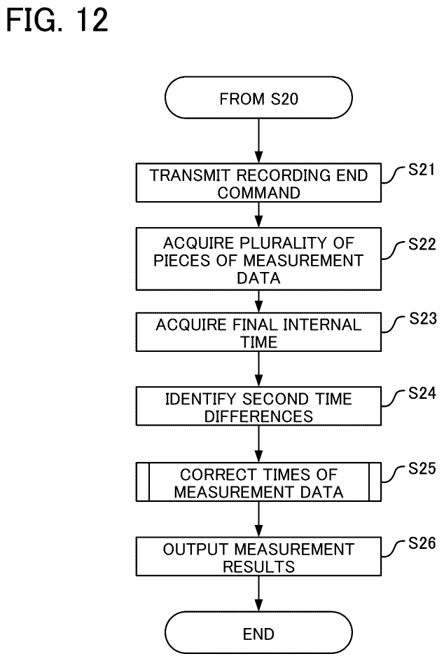

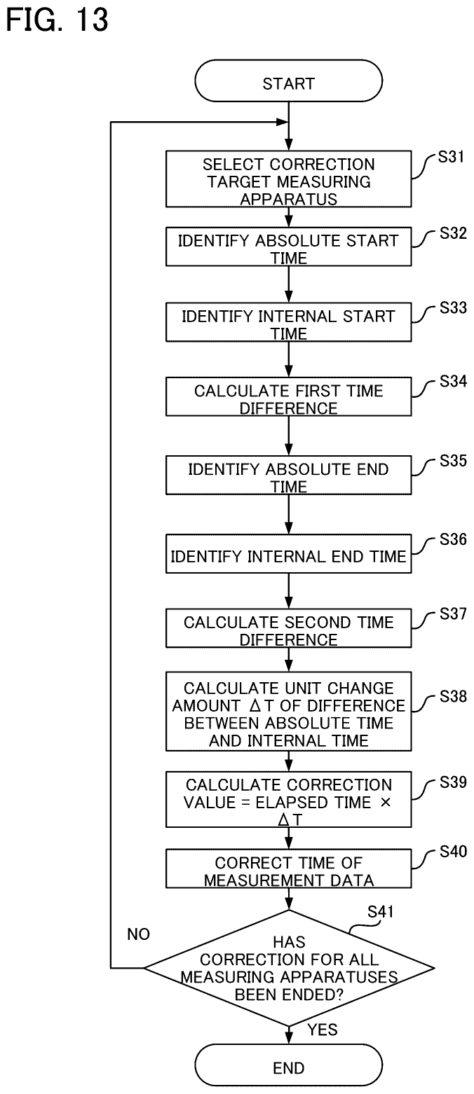

FIGS. 11 to 13 are flowcharts illustrating a processing procedure performed in the data processing apparatus 1. FIGS. 11 and 12 illustrate the processing procedure from the start until the end of measurement in a single measurement period. FIG. 13 illustrates the processing procedure of correction of the internal times corresponding to measurement data.

The flowchart illustrated in FIG. 11 is started at the time point when all measuring apparatuses 4 are in the sleep state. As an example, the command generating section 182 monitors whether the timing for activating the measuring apparatuses 4, that is, a measurement period, has come (S11). In a case where the command generating section 182 determines that a measurement period has come (YES at S11), the command generating section 182 selects measuring apparatuses 4 that are within a predetermined range from the position of the ship 100 and are in the sleep state (S12). The command generating section 182 transmits the activation command to the selected measuring apparatuses 4 (S13).

In parallel with the operations at S12 and S13 or after the operation at S13, the command generating section 182 selects measuring apparatuses 4 that are within a predetermined range from the position of the ship 100 and have not completed synchronization (S14). The command generating section 182 transmits the synchronization command to the selected measuring apparatuses 4 (S15).

When the data acquiring section 183 has received, from each measuring apparatus 4 having received the synchronization command, the internal time of the measuring apparatus 4, the time difference identifying section 184 identifies the first time difference on the basis of the relationship between the absolute time and the internal time at which the command generating section 182 has transmitted the synchronization command. The time difference identifying section 184 causes the storage section 17 to store the identified first time difference in association with the ID of the measuring apparatus 4 (S16). The time difference identifying section 184 may not identify the first time difference at this time point, but the data acquiring section 183 may cause the storage section 17 to store the absolute time at which the synchronization command has been transmitted and the internal time received from the measuring apparatus 4 in association with each other.

The command generating section 182 transmits the recording start command to measuring apparatuses 4 from which response data to the synchronization command has been received (S17). The command generating section 182 refers to the management table stored in the storage section 17 to determine whether all the measuring apparatuses 4 have completed synchronization and completed preparation for recording measurement data (S18). In a case where preparation of all the measuring apparatuses 4 has not been completed (NO at S18), the command generating section 182 repeats the processes from S12 to S17. In a case where preparation of all the measuring apparatuses 4 has been completed (YES at S18), the command generating section 182 notifies the seismic source control section 181 that preparation for measurement has been completed, and the seismic source control section 181 causes the seismic source 2 to generate seismic waves (S19).

The seismic source control section 181 causes the seismic source 2 to generate seismic waves until the scheduled last measurement ends (NO at S20). In a case where the scheduled last measurement has ended (YES at S20), the seismic source control section 181 notifies the command generating section 182 that the measurement has ended.

Next, the procedure proceeds to FIG. 12, and the command generating section 182 transmits the recording end command to the measuring apparatuses 4 via the data transmitting/receiving section 14 (S21). Thereby, the measuring apparatuses 4 having received the recording end command end measurement data recording and transition to the standby state. The data acquiring section 183 acquires a plurality of pieces of measurement data via the optical communication apparatus 3 (S22). The data acquiring section 183 causes the storage section 17 to store the acquired plurality of pieces of measurement data in association with the IDs of the measuring apparatuses 4.

In addition, the data acquiring section 183 acquires, via the data transmitting/receiving section 14, the absolute time at the time point when the optical communication apparatus 3 has requested the internal times from the measuring apparatuses 4 in response to the end of measurement and the internal times that the optical communication apparatus 3 has acquired from the measuring apparatuses 4 (S23). The time difference identifying section 184 identifies the second time difference on the basis of the absolute time of the time point at which the measurement has ended and the internal time of each measuring apparatus 4 at that time point, the absolute time and the internal time having been acquired by the data acquiring section 183 (S24). The time difference identifying section 184 causes the storage section 17 to store the identified second time differences in association with the IDs of the measuring apparatuses 4.

Thereafter, the correcting section 185 analyzes a plurality of pieces of measurement data. The correcting section 185 corrects the internal time associated with a plurality of pieces of measurement data on the basis of the first time difference and the second time difference stored in the storage section 17 in association with the ID of each measuring apparatus 4 (S25). The correcting section 185 outputs measurement results including the plurality of pieces of corrected measurement data (S26).

FIG. 13 is a flowchart illustrating the procedure of the measurement data correction process (S25). First, the correcting section 185 selects a measuring apparatus 4 whose measurement data is to be corrected (S31). Any method can be used by the correcting section 185 for selecting a measuring apparatus 4, and, for example, the correcting section 185 selects measuring apparatuses 4 in the order of their IDs.

Next, the correcting section 185 identifies the absolute start time stored in the storage section 17 in association with the ID of the selected measuring apparatus 4 (S32). In addition, the correcting section 185 identifies the internal start time corresponding to the absolute start time (S33). The correcting section 185 calculates the first time difference on the basis of the absolute start time and the internal start time (S34). As mentioned above, the correcting section 185 may calculate the first time difference further on the basis of the time required for the first acoustic signal including the synchronization command to reach the measuring apparatus 4 after the positional information acquiring section 11 has transmitted the first acoustic signal.

The correcting section 185 identifies the absolute end time and the internal end time stored in the storage section 17 in association with the ID of the selected measuring apparatus 4 (S35 and S36). The correcting section 185 calculates the second time difference on the basis of the absolute end time and the internal end time (S37). The correcting section 185 may calculate the second time difference further on the basis of the time required for the first optical signal for requesting the internal time to reach the measuring apparatus 4 after the positional information acquiring section 11 has transmitted the first optical signal.

Next, the correcting section 185 calculates a change amount ΔT per unit time of the difference between the absolute time and the internal time on the basis of the first time difference and the second time difference (S38). Specifically, the correcting section 185 calculates the change amount ΔT by dividing the difference between the first time difference and the second time difference by the elapsed time from the absolute start time until the absolute end time.

Next, the correcting section 185 calculates a correction value corresponding to the internal time at which each piece of the measurement data has been acquired, by multiplying the elapsed time from the measurement start internal time until the internal time by the unit amount ΔT (S39). The correcting section 185 calculates a corrected internal time by adding the calculated correction value to the internal time at which each piece of the measurement data has been acquired. The correcting section 185 corrects the time corresponding to the measurement data corresponding to the selected measuring apparatus 4 by updating the internal time of each piece of the measurement data to the corrected internal time (S40). The correcting section 185 may correct the internal time corresponding to all the pieces of the measurement data or may correct the internal time corresponding to some pieces of the measurement data that are necessary for analyzing natural seismic waves. The correcting section 185 causes the storage section 17 to store the measurement data and the corrected time in association with each other.

In a case where correction of the measurement data of all the measuring apparatuses 4 has not been completed (NO at S41), the correcting section 185 repeats the processes from S31 to S40. In a case where correction of the measurement data of all the measuring apparatuses 4 has been completed (YES at S41), the correcting section 185 ends the correction process.

### [Advantages of Data Processing Apparatus 1]

As explained above, the data processing apparatus 1 has: the time difference identifying section 184 that identifies the first time difference, which is the difference between the absolute start time and the internal time of the time point when a measurement period has started, and the second time difference, which is the difference between the absolute end time and the internal time of the time point when the measurement period has ended; and the correcting section 185 that corrects the internal time associated with a plurality of pieces of measurement data on the basis of the first time difference and the second time difference. By the correction of internal times of measurement data performed by the data processing apparatus 1 in this manner, even in a case a measuring apparatus 4 is not connected to a PTP network and cannot recognize the absolute time, it is possible for the data processing apparatus 1 to highly precisely identify the relationship between seismic waves and natural seismic waves detected by the measuring apparatus 4 without affecting the time required for measurement almost at all.

### First Modification Example

Whereas the data processing apparatus 1 identifies the first time difference and the second time difference in the measurement system S explained above, a measuring apparatus 4 may identify the first time difference and the second time difference and correct the internal time associated with measurement data. In this case, the measuring apparatus 4 generates measurement data associated with the corrected internal time (i.e. a time nearly equal to the absolute time), and the data processing apparatus 1 can acquire the measurement data associated with the corrected internal time.

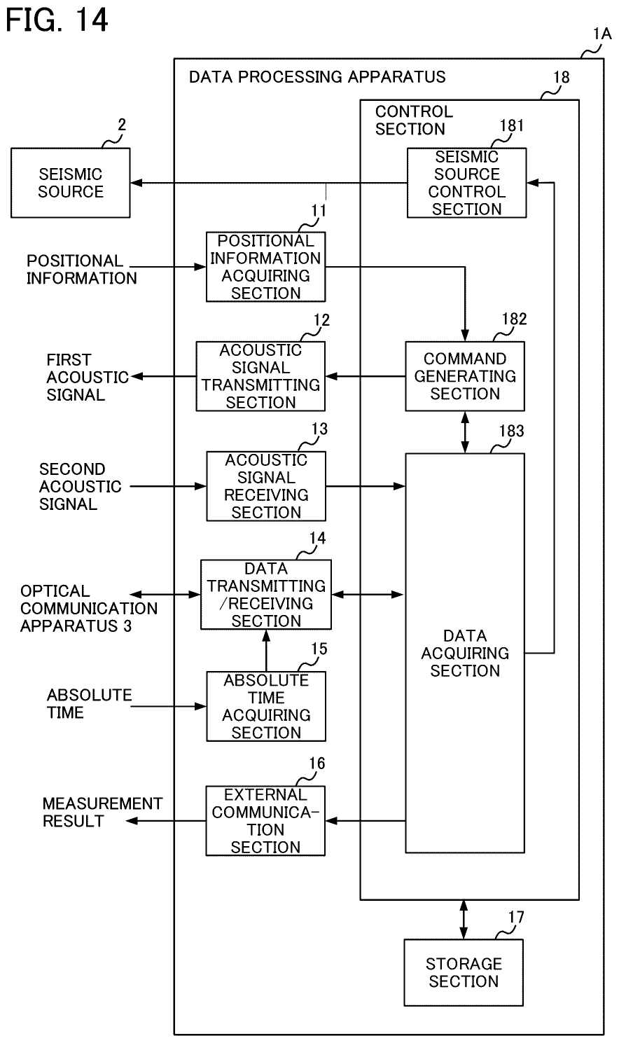

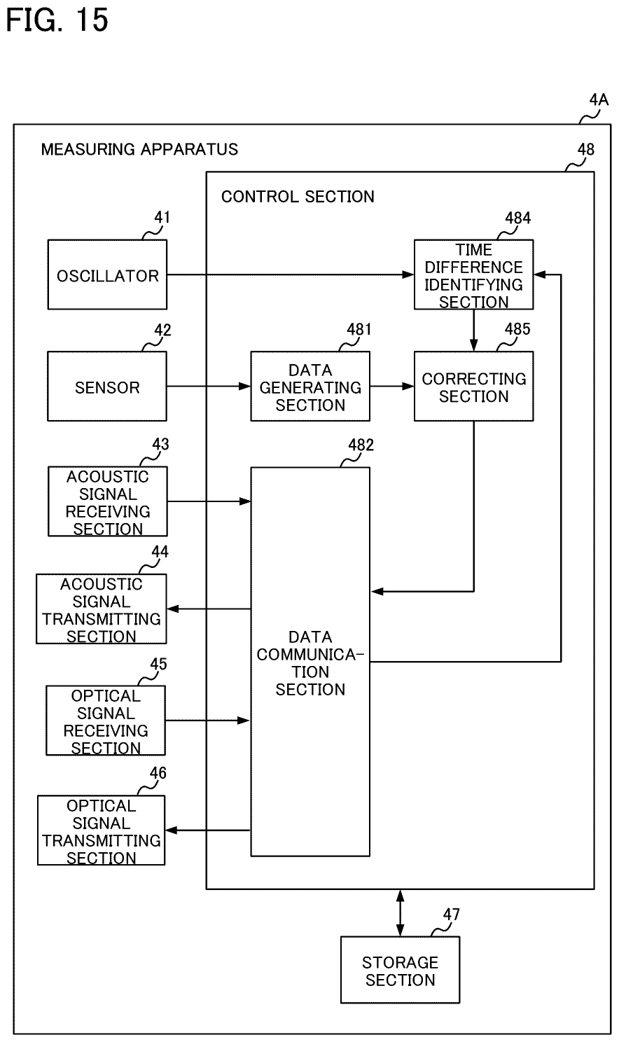

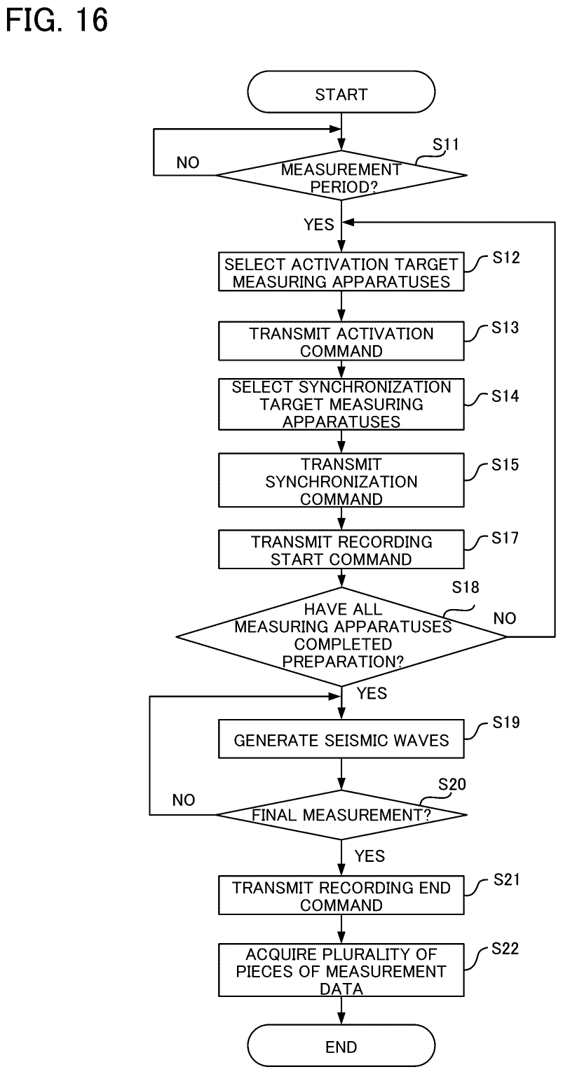

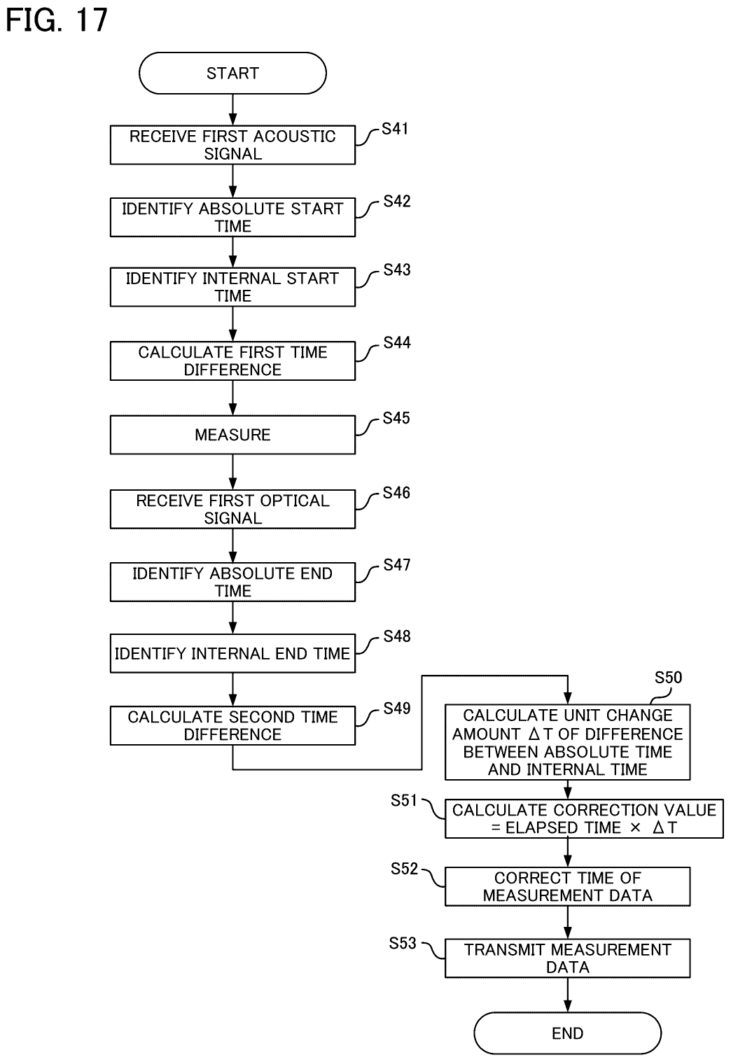

FIG. 14 is a diagram illustrating the configuration of a data processing apparatus 1A according to the present modification example. FIG. 15 is a diagram illustrating the configuration of a measuring apparatus 4A according to the present modification example. FIG. 16 is a flowchart illustrating a processing procedure performed in the data processing apparatus 1A according to the present modification example. FIG. 17 is a flowchart illustrating a processing procedure performed in the measuring apparatus 4A according to the present modification example.

First, the difference between the configuration of the data processing apparatus 1A and the configuration of the data processing apparatus 1 is explained with reference to FIG. 14. The data processing apparatus 1A is different from the data processing apparatus 1 in that the data processing apparatus 1A does not have the time difference identifying section 184 and the correcting section 185 that the data processing apparatus 1 illustrated in FIG. 4 has. The functions of individual sections illustrated in FIG. 14 are equivalent to the functions of individual sections denoted by the same reference characters in the data processing apparatus 1 illustrated in FIG. 4.

The data acquiring section 183 acquires, via the data transmitting/receiving section 14, measurement data whose internal times have been corrected at measuring apparatuses 4. Since the times associated with the measurement data acquired by the data acquiring section 183 are nearly equal to the absolute time, the times can be used for analysis as is. In view of this, the data acquiring section 183 externally transmits measurement results including the acquired measurement data via the external communication section 16.

Next, the difference between the configuration of the measuring apparatus 4A and the configuration of the measuring apparatus 4 is explained with reference to FIG. 15. The measuring apparatus 4A is different from the measuring apparatus 4 illustrated in FIG. 5 in that, in addition to the configuration that the measuring apparatus 4 illustrated in FIG. 5 has, the measuring apparatus 4A has a time difference identifying section 484 and a correcting section 485. The measuring apparatus 4A may further have the calibrating section 483 illustrated in FIG. 9.

After the data communication section 482 acquires the synchronization command via the acoustic signal receiving section 43, the data communication section 482 notifies the time difference identifying section 484 of the absolute time included in the synchronization command. The time difference identifying section 484 identifies the time difference between the internal time at that time point and the notified absolute time, as the first time difference at the time of a measurement start. The time difference identifying section 484 causes the storage section 47 to store the identified first time difference.

In addition, after the data communication section 482 acquires the absolute time of the time point when measurement has ended via the acoustic signal receiving section 43 or the optical signal receiving section 45, the data communication section 482 notifies the time difference identifying section 484 of the acquired absolute time. The time difference identifying section 484 identifies the time difference between the internal time at that time point and the notified absolute time, as the second time difference at the time of a measurement end. The time difference identifying section 484 causes the storage section 47 to store the identified second time difference.

The time difference identifying section 484 can execute processes equivalent to those executed by the time difference identifying section 184. For example, the time difference identifying section 484 calculates the first time difference on the basis of the difference between the absolute time and the internal time and the propagation time required for the first acoustic signal transmitted from the data processing apparatus 1A to reach the measuring apparatus 4A. In addition, the time difference identifying section 484 calculates the second time difference on the basis of the difference between the absolute time and the internal time and the propagation time required for the first optical signal transmitted from the optical communication apparatus 3 to reach the measuring apparatus 4A.

The correcting section 485 corrects the internal time at which the sensor 42 has output measurement data on the basis of the first time difference and second time difference identified by the time difference identifying section 484. Similarly to the correcting section 185, the correcting section 485 identifies a change amount per unit time of the difference between the absolute time and the internal time on the basis of: the time difference between the absolute start time, which is the absolute time of the measurement start time point, and the absolute end time, which is the absolute time of the measurement end time point; and the difference between the first time difference and the second time difference. Next, on the basis of the identified change amount, the correcting section 485 corrects the internal time associated with each of a plurality of pieces of measurement data generated by the data generating section 481. The correcting section 485 notifies the data communication section 482 of the corrected internal time in association with the measurement data.

The data communication section 482 transmits, to the optical communication apparatus 3 via the optical signal transmitting section 46, the plurality of pieces of measurement data notified from the correcting section 485 and associated with the corrected internal time.

The flowchart of the data processing apparatus 1A illustrated in FIG. 16 illustrates the processing procedure from the start of measurement during a single measurement period until the acquisition of measurement data by the data processing apparatus 1A. The processes from S11 to S20 in the flowchart illustrated in FIG. 16 are different from the flowchart illustrated in FIG. 11 in that the processes in the flowchart illustrated in FIG. 16 do not have the process of identifying the first time difference (S16), but are the same in other respects.

The flowchart in the measuring apparatus 4A illustrated in FIG. 17 starts at the time point when the data processing apparatus 1 transmits the first acoustic signal including the synchronization command. After the acoustic signal receiving section 43 receives the first acoustic signal including the synchronization command (S41), the time difference identifying section 484 identifies, as the absolute start time, the absolute time included in the synchronization command (S42). In addition, the time difference identifying section 484 identifies, as the internal start time, the internal time at this time point (S43). The time difference identifying section 484 calculates, as the first time difference, the difference between the absolute start time and the internal start time (S44).

Thereafter, the measuring apparatus 4A executes measurement of natural seismic waves (S45), and the data generating section 481 generates measurement data associated with the internal time output by the oscillator 41. After the last measurement ends, the optical signal receiving section 45 receives, from the optical communication apparatus 3, the first optical signal including the absolute time (S46). The time difference identifying section 484 identifies, as the absolute end time, the absolute time included in the first optical signal (S47). In addition, the time difference identifying section 484 identifies, as the internal end time, the internal time at this time point (S48). The time difference identifying section 484 calculates, as the second time difference, the difference between the absolute end time and the internal end time (S49).

Next, the correcting section 485 calculates the change amount ΔT per unit time of the difference between the absolute time and the internal time on the basis of the first time difference and the second time difference (S50). Specifically, the correcting section 485 calculates the change amount ΔT by dividing the difference between the first time difference and the second time difference by the elapsed time from the absolute start time until the absolute end time.

Next, the correcting section 485 calculates a correction value corresponding to the internal time at which each piece of the measurement data has been acquired, by multiplying the elapsed time from the measurement start internal time until the internal time by the unit amount ΔT (S51). The correcting section 485 calculates a corrected internal time by adding the calculated correction value to the internal time at which each piece of the measurement data has been acquired. The correcting section 185 corrects the time corresponding to the measurement data by updating the internal time of each piece of the measurement data to the corrected internal time (S52). The correcting section 485 may correct the internal time corresponding to all the pieces of the measurement data or may correct the internal time corresponding to some pieces of the measurement data that are necessary for analyzing natural seismic waves.

The correcting section 485 inputs the measurement data associated with the corrected time to the data communication section 482. The data communication section 482 transmits the measurement data whose time has been corrected to the optical communication apparatus 3 via the optical signal transmitting section 46 (S53).

### Second Modification Example

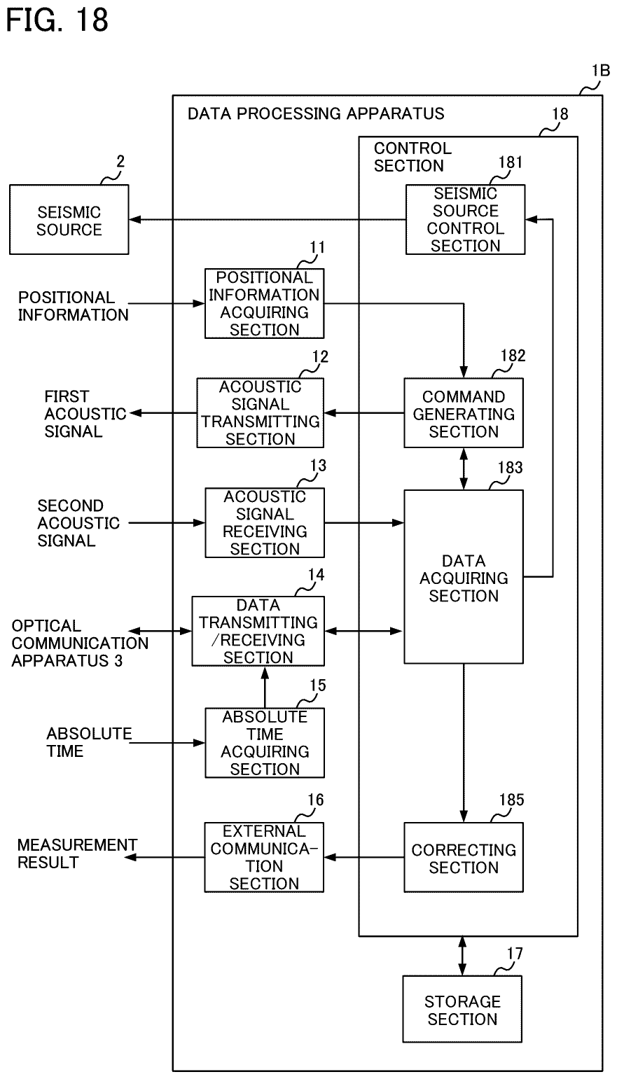

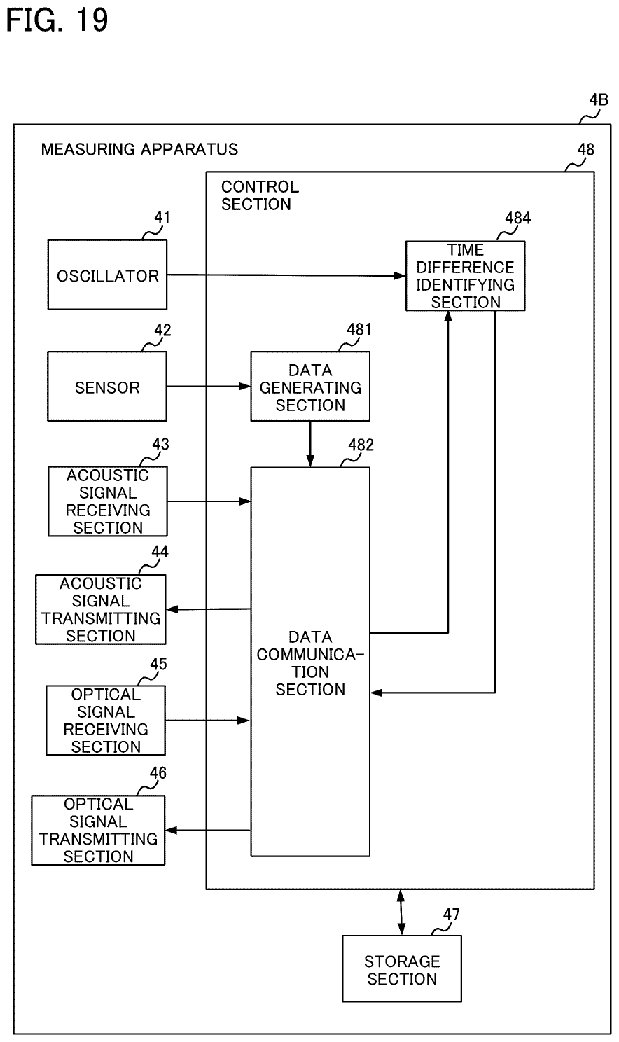

FIG. 18 is a diagram illustrating the configuration of a data processing apparatus 1B according to a second modification example. FIG. 19 is a diagram illustrating the configuration of a measuring apparatus 4B according to the second modification example. In the second modification example, the data processing apparatus 1B is different from the data processing apparatus 1A in the first modification example in that the data processing apparatus 1B has the correcting section 185. In addition, whereas the measuring apparatus 4A has the time difference identifying section 484 and the correcting section 485 in the first modification example, the second modification example is different also in that the measuring apparatus 4B has the time difference identifying section 484, but does not have the correcting section 485.

The time difference identifying section 484 of the measuring apparatus 4B operates similarly to the time difference identifying section 484 of the measuring apparatus 4A. That is, the time difference identifying section 484 calculates the first time difference on the basis of the difference between the absolute time and the internal time and the propagation time required for the first acoustic signal transmitted from the data processing apparatus 1A to reach the measuring apparatus 4A. In addition, the time difference identifying section 484 calculates the second time difference on the basis of the difference between the absolute time and the internal time and the propagation time required for the first optical signal transmitted from the optical communication apparatus 3 to reach the measuring apparatus 4A. The time difference identifying section 484 inputs the identified first time difference and second time difference to the data communication section 482.

In addition, the data generating section 481 of the measuring apparatus 4B inputs a plurality of pieces of measurement data output by the sensor 42 to the data communication section 482 in association with the internal time. Via the optical signal transmitting section 46, the data communication section 482 transmits the plurality of pieces of measurement data to the data processing apparatus 1B in association with the internal time and transmits the identified first time difference and second time difference identified by the time difference identifying section 484 to the data processing apparatus 1B.

In the data processing apparatus 1, after the data acquiring section 183 acquires the plurality of pieces of measurement data and the first time difference and second time difference, similarly to the data processing apparatus 1, the correcting section 185 corrects the internal time associated with the plurality of pieces of measurement data. In this manner, whether each of the time difference identifying section and the correcting section is provided to the data processing apparatus or provided to a measuring apparatus can be determined as desired.

Whereas the present disclosure has been explained using an embodiments thus far, the technical scope of the present disclosure is not limited by the scope described in the embodiments described above, but various modifications and changes are possible within the scope of a gist of the present disclosure. For example, all or some of apparatuses can be configured functionally or physically distributed or integrated in any units. In addition, new embodiments that are generated by any combination of a plurality of embodiments are also included in embodiments of the present disclosure. Advantages of the new embodiments generated by the combination combine advantages of the original embodiments.

What is claimed is:

1. A measurement system comprising:
a measuring apparatus installed on a seafloor; and a data processing apparatus that analyzes measurement data of a natural seismic wave detected by the measuring apparatus in response to generation of a seismic wave toward the seafloor from a seismic source during a measurement period from a ship sailing a sea, wherein
the measuring apparatus has:
an oscillator used for time measurement; and
a measurement data generating section that generates a plurality of pieces of the measurement data associated with an internal time obtained by the time measurement performed on a basis of the oscillator,
either the measuring apparatus or the data processing apparatus has:
a time difference identifying section that identifies: (1) a first time difference which is a difference between an absolute start time of a time point when the measurement period has started and the internal time associated with the measurement data obtained at the time point when the measurement period has started and (2) a second time difference which is a difference between an absolute end time of a time point when the measurement period has ended and the internal time associated with the measurement data obtained at the time point when the measurement period has ended; and
a correcting section that corrects the internal time associated with the plurality of pieces of measurement data at least on a basis of the first time difference and the second time difference.

2. The measurement system according to claim 1, wherein the correcting section identifies a change amount per unit time of a difference between an absolute time and the internal time on a basis of: a time difference between the absolute start time and the absolute end time; and a difference between the first time difference and the second time difference, and corrects the internal time associated with the plurality of pieces of measurement data on a basis of the identified change amount.

3. The measurement system according to claim 2, wherein the correcting section identifies a difference between an absolute time and the internal time at the internal time by adding, to the first time difference, a value obtained by multiplying elapsed time from the absolute start time until the internal time by the change amount and corrects the internal time on a basis of the identified difference.

4. The measurement system according to claim 1, wherein
the data processing apparatus further has a signal transmitting section that transmits a first acoustic signal including an absolute time,
the measuring apparatus further has an acoustic signal receiving section that receives the first acoustic signal, and
the time difference identifying section identifies at least either one of the first time difference or the second time difference on a basis of a difference between the absolute time represented by the first acoustic signal and the internal time obtained at a time point when the measuring apparatus has received the first acoustic signal.

5. The measurement system according to claim 4, wherein the time difference identifying section identifies at least either one of the first time difference or the second time difference on a basis of a difference between: a time obtained by adding time required for the first acoustic signal to reach the measuring apparatus to the absolute time represented by the first acoustic signal; and the internal time obtained at the time point when the measuring apparatus has received the first acoustic signal.

6. The measurement system according to claim 1, wherein
the measurement system further comprises an optical communication apparatus that generates a first optical signal representing an absolute time to the measuring apparatus underwater,
the measuring apparatus further has an optical signal receiving section that receives the first optical signal generated by the optical communication apparatus, and
the time difference identifying section identifies at least either one of the first time difference or the second time difference on a basis of a difference between a light emission time at which the optical communication apparatus has generated the first optical signal and the internal time obtained at a time point when the measuring apparatus has received the first optical signal.

7. The measurement system according to claim 1, wherein
the measurement system further comprises an optical communication apparatus that generates a first optical signal representing an absolute time to the measuring apparatus underwater,
the data processing apparatus further has a signal transmitting section that transmits a first acoustic signal including control data for controlling the measuring apparatus,
the measuring apparatus further has:
an optical signal receiving section that receives the first optical signal generated by the optical communication apparatus; and
an acoustic signal receiving section that receives the first acoustic signal, and
the time difference identifying section identifies the first time difference on a basis of a difference between an absolute time at which the signal transmitting section has transmitted the first acoustic signal and the internal time obtained at a time point when the measuring apparatus has received the first acoustic signal and identifies the second time difference on a basis of a difference between a light emission time at which the optical communication apparatus has generated the first optical signal and the internal time obtained at a time point when the measuring apparatus has received the first optical signal.

8. The measurement system according to claim 1, wherein
the correcting section identifies a frequency deviation of the oscillator of the measuring apparatus at a time point when the measurement period has ended on a basis of the first time difference and the second time difference and notifies the measuring apparatus of the identified frequency deviation, and
the measuring apparatus further has a calibrating section that calibrates a frequency of the oscillator on a basis of the frequency deviation notified from the data processing apparatus.

9. The measurement system according to claim 1, wherein
the measurement system comprises a plurality of the measuring apparatuses that are installed at mutually different positions,
the data processing apparatus further has:
a signal transmitting section that transmits a first acoustic signal including control data for controlling the measuring apparatus; and
a signal receiving section that receives a second acoustic signal generated by the measuring apparatus having received the first acoustic signal, and
the signal transmitting section transmits, to each of the plurality of measuring apparatuses, the first acoustic signal including activation data for activating the measuring apparatus and transmits the first acoustic signal including time data to the measuring apparatus from which the second acoustic signal including response data to the activation data has been received by the signal receiving section.

10. The measurement system according to claim 9, wherein
the data processing apparatus is mounted on the ship, and has:
a storage section that stores, in association with each other, a position of each of the plurality of measuring apparatuses and identification information of the measuring apparatus; and
a positional information acquiring section that acquires positional information representing a position of the ship, and
the signal transmitting section transmits the first acoustic signal including the time data to the measuring apparatus within a predetermined range from the position represented by the positional information by referring to the position of each of the plurality of measuring apparatuses stored in the storage section.

11. The measurement system according to claim 10, wherein the signal transmitting section transmits the first acoustic signal including recording start data representing an instruction for starting measurement data recording to the measuring apparatus from which a response to the first acoustic signal including the time data has been received by the signal receiving section.

12. The measurement system according to claim 11, wherein the measurement system further comprises a control apparatus that notifies the seismic source that the seismic wave is allowed to be generated, after the signal transmitting section has transmitted the first acoustic signal including the recording start data to a plurality of the measuring apparatuses.

13. A data processing apparatus comprising:
a data acquiring section that acquires a plurality of pieces of measurement data, the plurality of pieces of measurement data representing a natural seismic wave detected by a measuring apparatus installed on a seafloor in response to generation of a seismic wave toward the seafloor from a seismic source during a measurement period from a ship sailing a sea, the plurality of pieces of measurement data being generated by the measuring apparatus and associated with an internal time obtained by time measurement performed at the measuring apparatus;
a time difference identifying section that identifies: (1) a first time difference which is a difference between an absolute start time of a time point when the measurement period has started and the internal time associated with the measurement data obtained at the time point when the measurement period has started and (2) a second time difference which is a difference between an absolute end time of a time point when the measurement period has ended and the internal time associated with the measurement data obtained at the time point when the measurement period has ended; and
a correcting section that corrects the internal time associated with the plurality of pieces of measurement data at least on a basis of the first time difference and the second time difference.

14. A measuring apparatus that measures, on a seafloor, a natural seismic wave generated in response to generation of a seismic wave toward the seafloor from a seismic source during a measurement period from a ship sailing a sea, the measuring apparatus comprising:
a data generating section that generates a plurality of pieces of measurement data associated with an internal time obtained by time measurement performed at the measuring apparatus;
a time difference identifying section that identifies: (1) a first time difference which is a difference between an absolute start time of a time point when the measurement period has started and the internal time associated with the measurement data obtained at the time point when the measurement period has started and (2) a second time difference which is a difference between an absolute end time of a time point when the measurement period has ended and the internal time associated with the measurement data obtained at the time point when the measurement period has ended; and
a correcting section that corrects the internal time associated with the plurality of pieces of measurement data at least on a basis of the first time difference and the second time difference.
